(19) United States
(12) Patent Application Publication
(10) Pub. No.: US 2025/0108337 A1
(43) Pub. Date: Apr. 3, 2025

(54) PH-RESPONSIVE ADSORPTIVE COMPOSITE POLYMERIC MEMBRANES

(71) Applicant: Khalifa University of Science and Technology, Abu Dhabi (AE)

(72) Inventors: Shadi Wajih Hasan, Abu Dhabi (AE); Hanaa Mohamed Samy Mohamed Saber Hegab, Abu Dhabi (AE); Fatema Hisham Shaikhsalem Bakheet Khamis, Abu Dhabi (AE)

(73) Assignee: Khalifa University of Science and Technology, Abu Dhabi (AE)

(21) Appl. No.: 18/374,197

(22) Filed: Sep. 28, 2023

(51) Int. Cl. B01D 69/12; B01D 67/00; B01D 71/48

(52) U.S. Cl. CPC B01D 69/12; B01D 67/0016; B01D 71/48; B01D 2259/124; B01D 2323/081; B01D 2323/21819; B01D 2323/219; B01D 2323/36; B01D 2325/02834; B01D 2325/18

(57) ABSTRACT

A composite polymeric membrane includes polylactic acid polymer and an additive component, wherein the additive component includes activated carbon functionalized with polyethylenimine. A method of filtering a liquid includes contacting a liquid with a composite polymeric membrane, wherein the liquid includes one or more metals and the membrane includes an additive component and a polylactic acid polymer, and wherein the additive component includes activated carbon functionalized with polyethylenimine.

### BACKGROUND

Human activities such as heavy industrialization, agricultural development, urbanization, and population growth have resulted in high contamination levels of water sources in recent years. Pesticides, pharmaceuticals, heavy metals, microplastics, and radioactive elements have extensively contaminated ground, surface, and drinking water. This pollution harms both human health and the environment. Accordingly, there is an immediate demand to develop novel and effective water remediation technologies capable of maintaining acceptable levels of pollutants, such as heavy metal, concentrations. Heavy metals are stable and non-biodegradable, making them toxic even at low concentrations as they accumulate in living tissues and organs. Therefore, it is important to monitor and regulate the levels of heavy metals in water resources to minimize adverse long-term health effects.

To combat this issue, it is crucial to develop new and efficient technologies for water treatment that can maintain safe levels of pollutant concentrations. These methods include coagulation-flocculation, biological degradation, activated sludge, sewage treatment, membrane separation, photocatalytic degradation, and adsorption. Adsorptive membranes can significantly help accelerate the removal of contaminants compared to conventional adsorbents because they have convective flow, which can easily remove pollutants by attaching the pollutants to internal and external binding sites. However, most adsorptive membranes generally have a trade-off between permeability and selectivity. Further, most adsorbents are fossil-based and have negative environmental impacts. Therefore, it is desirable to provide an environmentally friendly filtration membrane capable of filtering pollutants while maintaining a high permeability and selectivity.

### SUMMARY

According to one aspect, a composite polymeric membrane includes polylactic acid polymer and an additive component, wherein the additive component includes activated carbon functionalized with polyethylenimine.

According to another aspect, a method of filtering a liquid includes contacting a liquid with a composite polymeric membrane, wherein the liquid includes one or more metals and the membrane includes an additive component and a polylactic acid polymer, and wherein the additive component includes activated carbon functionalized with polyethylenimine.

According to another aspect, a method of forming a filtration membrane includes contacting an additive component with a solvent to form a solution, wherein the additive component includes activated carbon functionalized with polyethylenimine; contacting the solution with polylactic acid; heating the solution at a temperature above 40° C.; removing gas from the solution; and shaping the degassed solution to form a structure.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates method 100 of filtering a liquid, according to some embodiments.

FIG. 2 illustrates a filtration system 200, according to some embodiments.

FIG. 3 illustrates method 300 of forming an additive component, according to some embodiments.

FIG. 4 illustrates method 400 of forming a filtration membrane, according to some embodiments.

FIG. 5 illustrates an example process of producing a modified activated carbon composite, according to some embodiments.

FIG. 6 illustrates an example process of producing a polymeric membrane, according to some embodiments.

FIG. 7A illustrates Fourier-transform infrared spectroscopy (FT-IR) spectra of AC, HNO₃-AC, PEI-AC, and MAC samples, according to some embodiments.

FIG. 7B illustrates Fourier-transform infrared spectroscopy (FT-IR) spectra of AC, HNO₃-AC, PEI-AC, and MAC samples, according to some embodiments.

FIG. 7C illustrates Fourier-transform infrared spectroscopy (FT-IR) spectra of AC, HNO₃-AC, PEI-AC, and MAC samples, according to some embodiments.

FIG. 7D illustrates Fourier-transform infrared spectroscopy (FT-IR) spectra of AMM samples, according to some embodiments.

FIG. 8 illustrates X-ray powder diffraction (XRD) spectra of HNO₃-AC, PEI-AC, MAC, and AMM powder samples, according to some embodiments.

FIG. 9 illustrates zeta (ζ) values of unmodified AC, AMM, and post-treatment and functionalization to get HNO₃-AC, PEI-AC, and MAC, according to some embodiments.

FIG. 10A illustrates a scanning electron microscope (SEM) image of AC, according to some embodiments.

FIG. 10B illustrates a scanning electron microscope (SEM) image of AMM, according to some embodiments.

FIG. 10C illustrates a scanning electron microscope (SEM) image of MAC, according to some embodiments.

FIG. 11 illustrates energy dispersive spectroscopy (EDS) elemental mapping of AC, AMM, and MAC composite, according to some embodiments.

FIG. 12 illustrates FT-IR spectra of PLA and MAC-PLA composite membranes, according to some embodiments.

FIG. 13 illustrates the porosity and mean pore radius of PLA and MAC-PLA composites with 1.5, 3, and 6 wt. % of MAC, according to some embodiments.

FIG. 14A illustrates SEM images of the top surface of PLA membranes, according to some embodiments.

FIG. 14B illustrates cross-sectional SEM images of PLA membranes, according to some embodiments.

FIG. 14C illustrates SEM images of the top surface of PLA membranes, according to some embodiments.

FIG. 14D illustrates cross-sectional SEM images of PLA membranes, according to some embodiments.

FIG. 15 illustrates the EDS mapping of a membrane top surface, according to some embodiments.

FIG. 16 illustrates the EDS mapping of C, O, Si, N, and Cl on cross-section images of various membranes, according to some embodiments.

FIG. 17 illustrates zeta (3) value of unmodified PLA, 1.5AC-PLA, 1.5MAC-PLA, 3MAC-PLA, and 6MAC-PLA membranes, according to some embodiments.

FIG. 18 illustrates dynamic water contact angle measurement of unmodified PLA and MAC composites, according to some embodiments.

FIG. 19 illustrates the weight loss of various membranes at various temperatures, according to some embodiments.

FIG. 20A illustrates pure water permeabilities of various membranes, according to some embodiments.

FIG. 20B illustrates heavy metal rejections of various membranes at pH 7, according to some embodiments.

FIG. 21A illustrates the pH effect on the water permeability of various membranes, according to some embodiments.

FIG. 21B illustrates the pH effect on heavy metal rejection of various membranes, according to some embodiments.

FIG. 22A illustrates the durability testing of 3MAC-PLA, according to some embodiments.

FIG. 22B illustrates the cyclic permeability results of various membranes, according to some embodiments.

FIG. 22C illustrates flux recovery ratio (FRR) results for various membranes, according to some embodiments.

FIG. 22D illustrates irreversible fouling ratios of various membranes, according to some embodiments.

### DETAILED DESCRIPTION

Embodiments of the present disclosure provide a novel approach to removing contaminants from liquids, such as water. Accordingly, novel filtration membranes, filtration methods, and methods of forming filtration membranes are described. These membranes may be natural, non-toxic, and biodegradable. Further, these membranes can include smart materials capable of responding to an external stimulus, such as a change in pH. Accordingly, the permeability and selectivity of the membranes may be tuned by altering the pore structure and/or surface charge of the membranes. Membranes of the present disclosure can be utilized for efficient ultrafiltration of water in small and large-scale applications. In one example, these membranes are designed for ultrafiltration of heavy metals sufficient for drinking water applications.

A composite polymeric membrane may be a water filtration membrane and may include one or more of a polylactic acid (PLA) polymer and an additive component. The composite polymeric membrane may be referred to as “membrane” in the present disclosure. Polylactic acid polymer is chemically stable and lacks toxicity. Further, polylactic acid polymer is a polymer with a low carbon footprint, high modulation, high mechanical and thermal strength, and biodegradability and biocompatibility. In one example, the weight percentage of polylactic acid in the composite polymeric membrane may range from about 5 wt. % to about 50 wt. %. In another example, the weight percentage of polylactic acid in the composite polymeric membrane may range from about 10 wt. % to about 30 wt. %. In yet another example, the weight percentage of polylactic acid in the composite polymeric membrane may range from about 15 wt. % to about 25 wt. %.

The additive component may be homogeneously distributed within, and in contact with, the polylactic acid polymer. Additionally, or alternatively, the additive component may be in contact with pores of the composite polymeric membrane and/or the polylactic acid polymer. The membrane may include an asymmetric morphology with a top skin layer and porous sublayers. In one example, the pores may include finger-like and/or macro voids. In another example, the membrane may include a selective top-layer barrier and a finger-like porous sublayer, wherein the membrane becomes more porous as the pores extend away from the surface and through the membrane. The additive component may be in contact with the outer surface of the polylactic acid polymer. In one example, the additive component and the polylactic acid polymer form a mixed matrix membrane where the additive component is integrated within the polylactic acid polymer.

The additive component may include an activated carbon (AC) compound, which may include more than 50 wt. %, more than 70 wt. %, more than 80 wt. %, or more than 90 wt. % activated carbon. Activated carbon may be negatively charged and may be produced from carbonaceous source materials with a high carbon content and a low ash content. Activated carbon may include a porous structure and may be derived from coal, wood, or coconut shells. Activated carbon may be produced using pyrolysis, oxidation, and chemical activation. The activated carbon in the activated carbon compound may include at least 70 wt. % carbon. For example, the activated carbon in the activated carbon compound may include at least 80 wt. % or at least 90 wt. % carbon.

The additive component may include one or more of hydroxyls, carboxyls, phenols, lactones, and ketones. Phenols may improve the filtration capability of the membrane. The additive component may include functionalized activated carbon. For example, the activated carbon may be functionalized with polyethylenimine. One or more functional groups may be added to the activated carbon. Accordingly, the functionalized activated carbon may include phenolic groups. Polyethylenimine may alter the activated carbon from negatively charged to positively charged. The additive component may include functional groups such as —NH, —NH₂, and —OH on the surface and in the membrane matrix. These functional groups may be considered water-holding moieties that can rapidly absorb water molecules.

The additive component may include mangrove particles. Mangrove particles may include particles from mangroves, such as from Avicennia marina mangrove (AMM) leaves. Mangrove particles may predominately include one or more of carbon, oxygen, and nitrogen. Mangrove particles may include lower concentrations of one or more of sodium, chlorine, magnesium, potassium, and calcium. The activated carbon compound may be cross-linked with these mangrove particles. Cross-linking may include the linking/joining of two or more components with chemical bonds. Accordingly, the additive component may include amino-functionalized activated carbon-modified mangrove particles. The functionalized activated carbon may be positively charged, and the mangrove particles may be negatively charged. In one example, the weight percentage of mangrove particles in the composite polymeric membrane ranges from about 0.01 wt. % to about 5 wt. %. In another example, the weight percentage of mangrove particles in the composite polymeric membrane ranges from about 0.1 wt. % to about 3 wt. %.

In one example, the weight percentage of the additive component in the composite polymeric membrane ranges from about 1 wt. % to about 20 wt. %. In another example, the weight percentage of the additive component in the composite polymeric membrane ranges from about 1 wt. % to about 15 wt. %. In yet another example, the weight percentage of the additive component in the composite polymeric membrane ranges from about 2 wt. % to about 6 wt. %. For example, the weight percentage of the additive component in the composite polymeric membrane may be about 3 wt. %. In one non-limiting example, a weight percentage of additive component above about 6 wt. %, above about 8 wt. %, or above about 10 wt. % occupies void spaces between polymer chains creating more tortuous paths for fluid flow. Additionally, these higher weight percentages may increase the amount of formed particle agglomerates during filtration, which may decrease permeability.

While the additive component may exhibit an overall negative charge, the additive component may reduce the overall surface negativity of the membrane compared to an unmodified polylactic acid polymer membrane. In one example, an unmodified polylactic acid polymer membrane includes pure polylactic acid. The additive component reduces the overall surface negativity by exhibiting local concentrations of negative charges close to the membrane surface. These negative sites can neutralize negative surface charges and/or make the surface charges less negatively charged. Further, while an unmodified polylactic acid polymer membrane is hydrophobic, the additive component increases the hydrophilicity of the membrane. In one example, the additive component may change the conformation or orientation of polymer chains on the membrane surface, leading to an alteration in surface charge distribution.

The additive component may increase the membrane pore size and make the surface more negatively charged, which may increase the surface area and interactions with water, resulting in a lower contact angle. An increased porosity provides more sites for water to penetrate and spread on the surface, leading to a larger contact area and a lower contact angle. The mean pore diameter of the composite polymeric membrane may range from about 0.1 μm to about 1 μm. In one example, the mean pore diameter of the composite polymeric membrane ranges from about 0.1 μm to about 0.6 μm. In another example, the mean pore diameter of the composite polymeric membrane ranges from about 0.15 μm to about 0.3 μm.

Importantly, the addition of the additive component to the membrane may increase the overall porosity compared to an unmodified PLA membrane. In one example, the porosity of the membrane may be greater than 75%. In another example, the porosity of the membrane may be greater than 85%. The total pore area (%) of the total composite polymeric membrane may range from about 5% to about 40%. In one example, the total pore area (%) of the total composite polymeric membrane ranges from about 10% to about 30%. In another example, the total pore area (%) of the total composite polymeric membrane ranges from about 22% to about 28%.

In one example, the average water contact angle of the membrane ranges from about 60 degrees to about 80 degrees. In another example, the average water contact angle of the membrane ranges from about 65 degrees to about 75 degrees. In yet another example, the average water contact area of the membrane ranges from about 68 degrees to about 73 degrees. Since the additive component is sufficient to decrease the contact angle of water on the membrane, the membrane may be more hydrophilic and more porous compared to an unmodified polylactic acid polymer membrane. By forming a more hydrophilic membrane, the water permeability of the membrane increases.

The thickness of the membrane may range from about 0.05 μm to about 500 μm. For example, the thickness of the membrane may range from about 100 μm to about 500 μm. The pure water permeability (PWP) of the membrane may range from about 1500 L·m⁻²·h⁻¹·bar⁻¹ to about 3500 L·m⁻²·h⁻¹·bar⁻¹. In one example, the pure water permeability of the membrane ranges from about 1700 L·m⁻²·h⁻¹ bar⁻¹ to about 2700 L·m⁻²·h⁻¹·bar⁻¹. In another example, the pure water permeability of the membrane ranges from about 2000 L·m⁻²·h⁻¹ bar⁻¹ to about 2500 L·m⁻²·h⁻¹·bar⁻¹. In one example, the additive component increases the water flux compared to an unmodified PLA membrane.

In one example, the composite polymeric membrane is sufficient for one or more of nanofiltration (˜1-10 nm), ultrafiltration, and microfiltration (˜0.1-1 μm). In another example, the composite polymeric membrane is sufficient for ultrafiltration. For example, the composite polymeric membrane may include an average pore size ranging from about 0.01 μm to about 0.5 μm. In another example, the composite polymeric membrane may filter/remove particles larger than 0.01 μm. In yet another example, the composite polymeric membrane may filter/remove particles larger than 0.1 μm. The membrane may filter water solutions including one or more heavy metals. For example, the unfiltered water solution may include a heavy metal concentration of greater than 10 ppm, greater than 20 ppm, greater than 30 ppm, or greater than 50 ppm. The unfiltered water solution may include a heavy metal concentration between about 10 ppm and about 50 ppm or between about 20 ppm and about 100 ppm.

One or more (heavy) metals may be toxic to living organisms at low concentrations. In one example, one or more metals are selected from copper, nickel, lead, manganese, cadmium, mercury, zinc, and arsenic. In another example, one or more metals may include two or more, or all of, copper, lead, and nickel. The membrane rejection of metals such as copper, lead, and nickel may be greater than 85%. In another example, the membrane rejection of metals such as copper, lead, and nickel may be greater than 90%. In yet another example, the membrane rejection of metals such as copper, lead, and nickel may be greater than 95%, greater than 97%, or greater than 99%. In one non-limiting example, the additive component exhibits a higher affinity toward metals of smaller hydrolysis constant values. One or more components within the membrane may form a chemical bond with one or more metals during adsorption.

The pH of the membrane may be altered to initiate a smart membrane response. Protonation and deprotonation of functional groups, such as phenolic groups, may occur at acidic and basic pH, respectively. Accordingly, increasing the pH of the membrane to a basic pH may modify the surface charge by increasing negatively charged deprotonated phenolic groups. Increasing the number of negatively charged deprotonated phenolic groups increases the overall attraction of heavy metal ions. Accordingly, the positive species, such as heavy metal ions, easily flow and/or adsorb on the negatively charged pores upon deprotonation of the phenolic groups, resulting in surface adsorption and metal complexation.

In one example, under basic conditions, metal ions exceed their solubility, forming insoluble metal hydroxide precipitates. For example, copper, lead, and nickel may form Cu(OH)₂, Pb(OH)₂, and Ni(OH)₂, respectively. In this example, the rejection percentage of the membrane may be increased by decreasing or increasing the pH from pH 7. In another example, at acidic pH levels, the metal ions form metal-hydrogen ion complexes, which are smaller in size than the metal ions alone. In yet another example, the negativity of the surface increases with an increase in pH. In one example, the pH of the membrane is between 2 pH and 11 pH. In another example, the pH of the membrane is between 7 pH and 11 pH. For example, the pH of the membrane may be about 8 pH, about 9 pH, about 10 pH, or values therebetween.

Importantly, the additive component in the membrane increases the water permeability of the membrane. The increased water permeability is attributed to the improved hydrophilicity and the increased pore size and porosity of the composite membrane. Further, the membranes of the present disclosure exhibit pH-responsive physical and chemical characteristics. Since the additive component may include phenolic groups, the membrane is capable of nearly complete removal of heavy metals such as lead, copper, and nickel. Additionally, the membrane exhibits enhanced anti-fouling properties, which is critical for the durability, maintenance cost, and lifespan of the membrane.

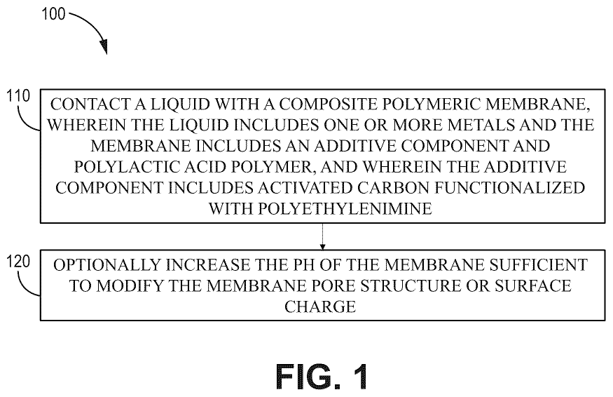

Referring to FIG. 1, a method of filtering a liquid is illustrated according to some embodiments. Method 100 includes one or more of the following steps:

STEP 110, CONTACT A LIQUID WITH A COMPOSITE POLYMERIC MEMBRANE, WHEREIN THE LIQUID INCLUDES ONE OR MORE METALS AND THE MEMBRANE INCLUDES AN ADDITIVE COMPONENT AND POLYLACTIC ACID POLYMER, AND WHEREIN THE ADDITIVE COMPONENT INCLUDES ACTIVATED CARBON FUNCTIONALIZED WITH POLYETHYLENIMINE, includes contacting a liquid, such as water, with a composite polymeric membrane, wherein the liquid includes one or more heavy metals, such as copper, lead, and/or nickel, and the membrane includes an additive component and polylactic acid. The one or more metals may include one or more heavy metals. Contacting may include placing the liquid and the membrane in fluidic communication, physically touching two or more components together, or pressurizing the liquid through the membrane. In one example, the one or more metals are selected from copper, nickel, lead, manganese, cadmium, mercury, zinc, and arsenic. In another example, the one or more metals may include two or more, or all of, copper, lead, and nickel.

The additive component may include activated carbon functionalized with polyethylenimine. In one example, the additive component includes functionalized activated carbon cross-linked with mangrove particles. In one example, the weight percentage of the additive component in the composite polymeric membrane ranges from about 1 wt. % to about 20 wt. %. In another example, the weight percentage of the additive component in the composite polymeric membrane ranges from about 1 wt. % to about 10 wt. %. In yet another example, the weight percentage of the additive component in the composite polymeric membrane ranges from about 2 wt. % to about 6 wt. %. For example, the weight percentage of the additive component in the composite polymeric membrane may be about 3 wt. %.

The additive component may increase the pore size and make the surface more negatively charged, which may increase the surface area and interactions with water, resulting in a lower contact angle. An increased porosity provides more sites for water to penetrate and spread on the surface, leading to a larger contact area and a lower contact angle. Further, the additive component may include functional groups such as —NH, —NH₂, and —OH on the surface and in the membrane matrix. These functional groups may be considered water-holding moieties that can rapidly absorb water molecules. Accordingly, the additive component may increase the hydrophilicity of the membrane. Increasing the hydrophilicity of the membrane may increase the liquid permeability of the membrane.

STEP 120, OPTIONALLY INCREASE THE PH OF THE MEMBRANE SUFFICIENT TO MODIFY THE MEMBRANE PORE STRUCTURE OR SURFACE CHARGE, includes optionally increasing the pH, such as from acidic (pH<7) or neutral pH (pH 7) to basic pH (pH>7), of the membrane sufficient to modify the membrane pore structure and/or surface charge. Increasing the pH of the membrane may include increasing the pH of the liquid. STEP 120 may alternatively include decreasing the pH, such as from basic pH (pH>7) or neutral pH (pH 7) to acidic pH (pH<7). In one example, the contacting step 110 may be performed at a pH between 2 pH and 11 pH. In another example, the contacting step 110 may be performed at a pH between 7 pH and 11 pH. For example, the contacting step 110 is performed at about 8 pH, about 9 pH, at about 10 pH, or values there between. Modifying the membrane pore structure and/or surface charge may improve the heavy metal rejection of the membrane. For example, the rejection of metals such as copper, lead, and nickel may be greater than 95%. In another example, the rejection of metals such as copper, lead, and nickel may be greater than 98%.

Altering the pH is sufficient to create a smart membrane response. The additive component may include phenolic groups. Protonation and deprotonation of functional groups, such as phenolic groups, may occur at acidic and basic pH, respectively. Accordingly, increasing the pH of the membrane to a basic pH may modify the surface charge by increasing negatively charged deprotonated phenolic groups. Increasing the number of negatively charged deprotonated phenolic groups increases the overall attraction of heavy metal ions. Accordingly, the positive species, such as heavy metal ions, easily flow and/or adsorb on the negatively charged pores upon deprotonation of the phenolic groups, resulting in surface adsorption and metal complexation. Furthermore, in one example, under basic conditions, metal ions exceed their solubility, forming insoluble metal hydroxide precipitates. For example, copper, lead, and nickel may form Cu(OH)₂, Pb(OH)₂, and Ni(OH)₂, respectively. In this example, the rejection percentage of the membrane may be increased. In another example, at acidic pH levels, the metal ions form metal-hydrogen ion complexes, which are smaller in size than the metal ions alone.

In one example, the composite polymeric membrane is sufficient for filtration. Filtration may include one or more of nanofiltration (˜1-10 nm), ultrafiltration, and microfiltration (˜0.1-1 μm). In another example, the composite polymeric membrane is sufficient for ultrafiltration. For example, the composite polymeric membrane may include an average pore size ranging from about 0.01 μm to about 0.1 μm. In another example, the composite polymeric membrane may filter/remove particles larger than 0.01 μm. In yet another example, the composite polymeric membrane may filter/remove particles larger than 0.1 μm.

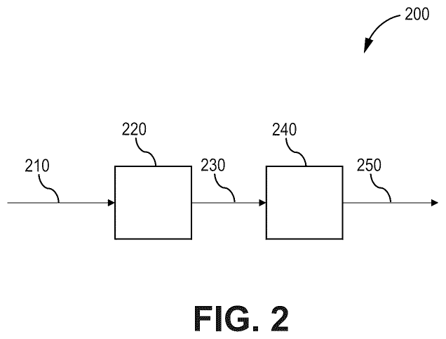

FIG. 2 illustrates a filtration system 200, according to some embodiments.

Filtration system 200 includes liquid source 210, pump 220, conduit 230, membrane 240, and outlet 250. Liquid source 210 may be in a fluidic connection with pump 220. Accordingly, liquid source 210, pump 220, conduit 230, and membrane 240 may be in fluidic communication. Liquid source 210 may include water and one or more metals. In one example, the one or more metals are selected from copper, nickel, lead, manganese, cadmium, mercury, zinc, and arsenic. In another example, the one or more metals may include two or more or all of copper, lead, and nickel. Liquid source 210 may further include an acidic or basic solution. For example, liquid source 210 may be treated to increase the pH to a pH above 7. Pump 220 may include a positive displacement pump, a centrifugal pump, or an axial-flow pump.

Conduit 230 is sufficient to transfer liquid(s) in liquid source 210 to membrane 240 for filtration. In one example, conduit 230 includes a fluid pipe for transferring liquid(s). In another example, conduit 230 includes a vessel defining a lumen for fluid transfer from pump 220 to membrane 240. Membrane 240 may be upstream or downstream of pump 220 and may be fluidically connected to conduit 230. Membrane 240 includes a composite polymeric membrane of the present disclosure, such as the membrane formed in method 400 below. Membrane 240 may further include a support structure for holding the membrane in place during filtration.

Liquid may be transferred through pores of membrane 240 and filtered prior to entering outlet 250. Outlet 250 may transfer filtered liquid(s) to downstream equipment or a downstream tank. Importantly, system 200 may filter metals from one or more liquids at various metal concentrations. For example, system 200 may be utilized for filtering liquids including a heavy metal (such as nickel, copper, and lead) concentration ranging from about 10 ppm to about 100 ppm. In another example, system 200 may be utilized for filtering liquids including a heavy metal (such as nickel, copper, and lead) concentration ranging from about 15 ppm to about 65 ppm. System 200 is sufficient to perform method 100 of the present disclosure.

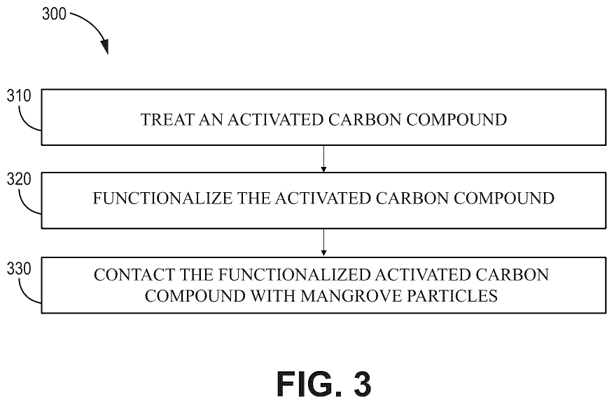

Referring to FIG. 3, a method 300 of forming an additive component is illustrated according to some embodiments. Method 300 may be used to form an additive component of the present disclosure and includes one or more of the following steps:

STEP 310, TREAT AN ACTIVATED CARBON COMPOUND, includes treating an activated compound with heat. Treating the activated carbon compound may include contacting and dispersing activated carbon with an acid such as a nitric acid solution. The acidic solution including activated carbon may be heated at a temperature above about 40° C. In one example, the acidic solution including activated carbon is heated at a temperature between 40° C. and 80° C. In another example, the acidic solution including activated carbon is heated at a temperature between 45° C. and 60° C. After heating, the treated activated carbon powder may be rinsed with water to achieve a pH of 7 and dried under vacuum. The treated activated carbon powder may be dried at a temperature above about 60° C. In one example, the treated activated carbon powder is dried at a temperature between 70° C. and 100° C. In another example, the treated activated carbon powder is dried at a temperature of about 80° C.

STEP 320, FUNCTIONALIZE THE ACTIVATED CARBON COMPOUND, includes modifying or functionalizing the activated carbon compound to form a functionalized powder. The treated activated carbon compound formed in STEP 310 may be contacted with a solvent solution, such as an ethanol solution. The solvent solution may include polyethylenimine (PEI). The treated activated carbon compound may be suspended in the solvent solution and ultrasonicated. In one example, ultrasonication includes using ultrasonic waves sufficient for homogenization. The dispersion may be stirred and/or heated at a temperature above 40° C. In one example, the dispersion is heated at a temperature between 40° C. and 70° C. In another example, the dispersion is heated at a temperature between 45° C. and 55° C. The dispersion may be stirred and heated until the solvent has evaporated. STEP 320 may include forming a functionalized activated carbon compound such as a polyethylenimine-activated carbon precipitate. Further, the formed precipitate may be washed and centrifuged to separate powder. The powder may be dried at a temperature above about 60° C. In one example, the powder is dried at a temperature between 70° C. and 100° C. In another example, the powder is dried at a temperature of about 80° C.

STEP 330, CONTACT THE FUNCTIONALIZED ACTIVATED CARBON COMPOUND WITH MANGROVE PARTICLES, includes contacting the functionalized activated carbon compound, formed from STEP 320, with a solution including hydroxyls and/or phenols, such as mangrove particles. Avicennia marina mangrove (AMM) leaves may be sieved (such as <200 μm, less than 150 μm, or less than 125 μm) and crushed. The sieved AMM may be solubilized into a buffer solution, such as trizma buffer solution. The solution may include an AMM concentration ranging from about 1 mg/mL to about 5 mg/mL. In one example, the solution may include an AMM concentration ranging from about 1.5 mg/mL to about 3 mg/mL. In another example, the buffer solution may include 50 mM of trizma buffer solution. In yet another example, the solution has a pH ranging from 8 to 10. For example, the solution may have a pH of about 8, about 8.5, about 9, or about 9.5.

The solution may be stirred and/or heated to induce cross-linking of the AMM with the functionalized activated carbon compound. The precipitate may be centrifuged and dried after cross-linking. In one example, the precipitate is dried at a temperature between 50° C. and 150° C. In another example, the precipitate is dried at a temperature between 75° C. and 125° C. Contacting the functionalized activated carbon compound with the solution including mangrove particles may be sufficient to form an additive component such as a cross-linked AMM-functionalized activated carbon compound.

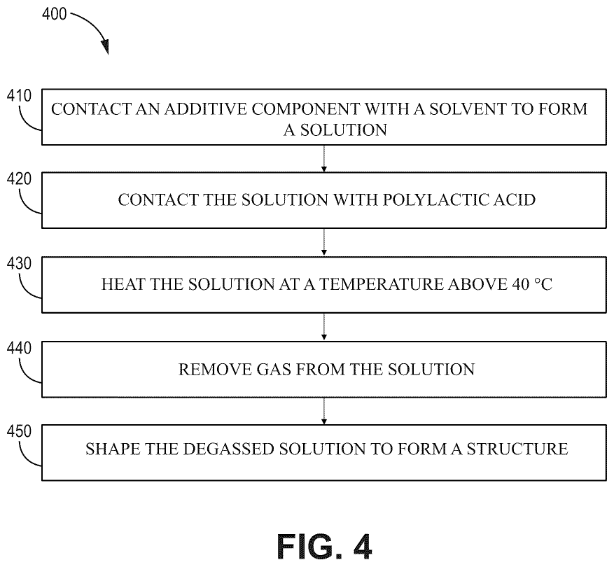

Referring to FIG. 4, a method 400 of forming a filtration membrane is illustrated according to some embodiments. Method 400 includes one or more of the following steps:

STEP 410, CONTACT AN ADDITIVE COMPONENT WITH A SOLVENT TO FORM A SOLUTION, includes contacting an additive component, such as the additive component formed in method 300, with a solvent to form a solution. In one example, the solvent includes an organic solvent. In another example, the solvent includes dimethylacetamide (DMAc). Contacting may include placing in close proximity, physically touching two or more components together, stirring, mixing, pouring, dissolving, and/or otherwise placing components in contact. Contacting the additive component with the solvent may include dispersing the additive component with sonication. For example, sonication may be performed for 1 minute to 1 hour. In another example, sonication may be performed for about 5 minutes to about 20 minutes. STEP 410 may further include adding a water-soluble polymer compound, such as polyvinylpyrrolidone (PVP, also known as polyvidone) to the solution. For example, PVP may be dissolved into the solution. The formed solution may include a homogeneous solution.

STEP 420, CONTACT THE SOLUTION WITH POLYLACTIC ACID, includes contacting the formed solution in STEP 410 with polylactic acid. Contacting may include placing in close proximity, physically touching two or more components together, stirring, mixing, pouring, dissolving, and/or otherwise placing components in contact. In one example, the polylactic acid includes a solid polylactic acid polymer. In another example, polylactic acid includes dried polylactic acid beads. The weight percentage of polylactic acid in the solution may range from about 5 wt. % to about 30 wt. %. For example, the weight percentage of polylactic acid in the solution may range from about 15 wt. % to about 25 wt. %. Once polylactic acid is fully added to the solution, the weight percentage of PVP in the solution may range from about 1 wt. % to about 5 wt. %. For example, once polylactic acid is fully added to the solution, the weight percentage of PVP in the solution may range from about 1 wt. % to about 3 wt. %. Polylactic acid beads may be gradually added to the solution while stirring the solution. In one example, the solution is stirred for 1 hour to 48 hours. In another example, the solution is stirred for about 2 hours to about 4 hours.

STEP 430, HEAT THE SOLUTION AT A TEMPERATURE ABOVE 40° C., includes heating the solution formed in STEP 420 at a temperature above 40° C. STEP 430 may be performed before, during, and/or after contacting the solution with polylactic acid. In one example, the solution is heated to/at a temperature above 50° C. In another example, the solution is heated to/at a temperature between about 50° C. and 90° C. In yet another example, the solution is heated to/at a temperature between about 60° C. and 80° C. After, the solution may be cooled to room temperature while being stirred. Room temperature may include a temperature between about 18° C. and 23° C. For example, room temperature may be about 20° C. In one example, the weight percentage of the additive component in the solution ranges from about 1 wt. % to about 20 wt. %. In another example, the weight percentage of the additive component in the solution ranges from about 1 wt. % to about 10 wt. %. In yet another example, the weight percentage of the additive component in the solution ranges from about 1.5 wt. % to about 6 wt. %. For example, the weight percentage of the additive component in the solution may be about 3 wt. %.

STEP 440, REMOVE GAS FROM THE SOLUTION, includes removing gas from the solution formed in STEP 420 or STEP 430. Accordingly, STEP 440 may be performed before, during, or after STEP 430. In one example, removing gas from the solution includes sonicating the solution. Sonicating the solution may be performed for 10 minutes to 3 hours. In one example, sonicating the solution may be performed for about 1 hour. In another example, removing gas from the solution includes degassing under vacuum at a temperature above room temperature. Room temperature may include a temperature between about 18° C. and 23° C. In yet another example, removing gas from the solution includes degassing under vacuum at a temperature of about 30° C., about 35° C., about 40° C., or about 45° C., or temperatures therebetween.

STEP 450, SHAPE THE DEGASSED SOLUTION TO FORM A STRUCTURE, includes shaping the degassed solution to form a structure sufficient for filtration. Shaping the degassed solution to form a structure may include using the phase inversion method. Shaping the degassed solution may include pouring the degassed solution onto a support. In one example, the support includes a non-woven polyester support, which may be attached to a glass casting plate. The solution may be spread over the support before being submerged in a coagulation bath. In one example, the formed structure is removed when the transparency of the casting plate changes to opacity. The formed structure may be rinsed with and/or submerged in water to remove one or more of DMAc and PVP. The thickness of the formed structure may range from about 50 μm to about 500 μm. For example, the thickness of the formed structure may range from about 100 μm to about 300 μm.

Method 400 may include non-solvent induced phase inversion (NIPS) and the steps may be performed in any order. Any two or more steps in method 400 may be performed simultaneously. The formed structure may include a membrane of the present disclosure, such as a membrane including a polylactic acid polymer and an additive component. In one example, the weight percentage of the additive component in the formed structure ranges from about 1 wt. % to about 20 wt. %. In another example, the weight percentage of the additive component in the formed structure ranges from about 1 wt. % to about 10 wt. %. In yet another example, the weight percentage of the additive component in the formed structure ranges from about 2 wt. % to about 6 wt. %. For example, the weight percentage of the additive component in the formed structure may be about 3 wt. %.

The mean pore diameter of the formed structure may range from about 0.1 μm to about 1 μm. In one example, the mean pore diameter of the formed structure ranges from about 0.1 μm to about 0.6 μm. In another example, the mean pore diameter of the formed structure ranges from about 0.15 μm to about 0.3 μm. The total pore area (%) of the total formed structure may range from about 5% to about 40%. In one example, the total pore area (%) of the total formed structure ranges from about 10% to about 30%. In another example, the total pore area (%) of the total formed structure ranges from about 22% to about 28%.

Importantly, the membranes of the present disclosure are capable of treating water to maintain safe levels of pollutant concentrations. These membranes may be utilized for removing contaminants and/or heavy metals from water in applications such as healthcare, food and beverage, municipal water treatment, and industrial wastewater treatment. Since heavy metals are stable and non-biodegradable, these heavy metals may be toxic even at low concentrations as they can accumulate in tissues and organs. By removing heavy metals from water, the water is safe for human consumption.

### Example 1—Synthesis of Amino-Functionalized Activated Carbon-Modified Mangrove (MAC)

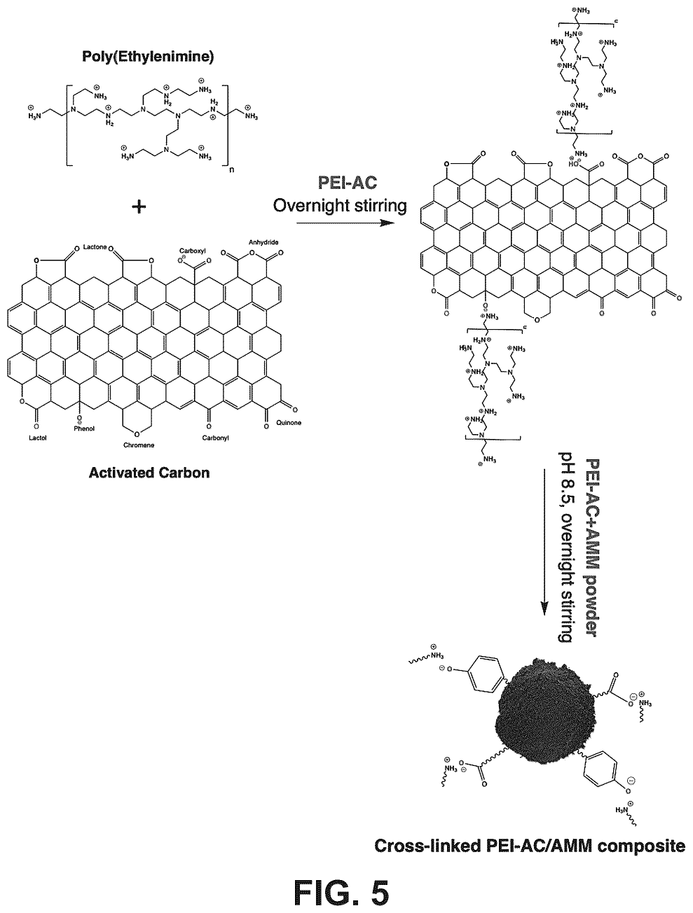

FIG. 5 illustrates an example process of producing a modified activated carbon (MAC) composite, according to some embodiments. The MAC composite includes amino-functionalized activated carbon-modified mangrove. The MAC composite was synthesized in three sequential steps: pretreatment, modification, and synthesis of the composite through heat-induced cross-linking. In the pretreatment step, 10 grams of activated carbon (AC) was dispersed into a solution of HNO₃ placed into a round-bottom flask, fixed in an oil bath and heated at 50° C. for 6 hours. The treated AC (HNO₃-AC) powder was then rinsed in deionized (DI) water to achieve a pH of 7, and was dried overnight under vacuum at 80° C. For the AC modification, HNO₃-AC was suspended and ultrasonicated for 30 minutes in an ethanol solution containing polyethylenimine (PEI). The dispersion was then poured into a clean round-bottom flask and stirred and heated at 300 rpm for 2 hours at 50° C., respectively, for complete evaporation of ethanol. The PEI-modified AC (PEI-AC) precipitate was washed and centrifuged three times at 5000 rpm for 20 minutes each. At the end of the last washing cycle, the mother liquor was poured out and the powder was kept drying overnight at 80° C. Lastly, in the amino-group functionalization of Avicennia marina mangrove (AMM) with PEI-AC, 2 mg·mL⁻¹ of sieved (<125 μm) and crushed AMM leaves powder was solubilized into 50 mM of trizma buffer solution, followed by the addition of PEI-AC into the solution with a pH of 8.5, which was stirred at 50 rpm overnight to allow heat-induced cross-linking. The precipitate was collected and centrifuged three times at 5000 rpm for 20 minutes each and kept drying overnight at 100° C.

### Example 2—Fabrication of Membranes

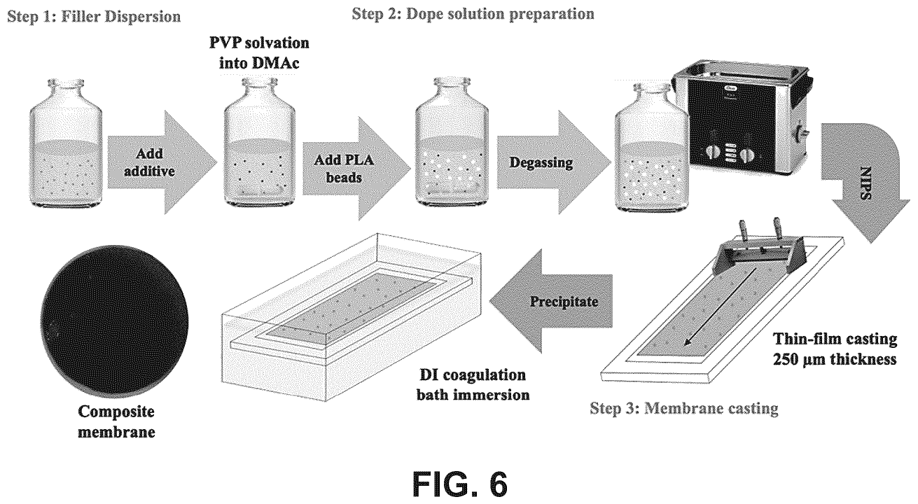

FIG. 6 illustrates an example process of producing a polymeric membrane, according to some embodiments. The membranes were prepared using the Non-solvent Induced Phase Inversion (NIPS) method. The ingredients used in the preparation of the homogenous dope solution are listed in Table 1, including the PLA polymer, the additive PVP, the filler (AC or MAC) and the organic solvent DMAc. The filler was dispersed into DMAc in a 50 mL glass vial through sonication for 1 hour at 40 kHz. PVP was then dissolved into the DMAc solution for 10 minutes at a speed of 150 rpm. Pre-dried PLA beads were gradually added to the PVP/DMAc mixture while being stirred for 3 hours at a temperature of 70° C. and a speed of 150 rpm. After, the solution was cooled to room temperature and continued to be stirred for another 24 hours. To eliminate gas bubbles, the solution was first sonicated for 1 hour and then degassed in a vacuum oven at 40° C. The degassed solution was poured onto a 150 μm thick non-woven polyester support that was attached to a casting glass plate. The solution was evenly spread over the support using an 8″ film casting knife with a gap depth of 250 μm. The glass plate containing the casted film was kept at 25° C. for 2 seconds before being submerged in a coagulation bath. When the transparency of the glass plate changed to opacity, the polymeric membrane was fully formed. To ensure that all traces of DMAc and water-soluble PVP were eliminated, the produced membrane was rinsed and then submerged in DI water for 48 hours or until further testing.

TABLE 1
Solution compositions of membranes

| | PLA | PVP (40 kDa) | AC | MAC |
|---|---|---|---|---|
| Membrane | (wt. %) | (wt. %) | (wt. %) | (wt. %) |
| PLA | 18 | 2 | 0 | 0 |
| 1.5AC-PLA | 18 | 2 | 1.5 | 0 |
| 1.5MAC-PLA | 18 | 2 | 0 | 1.5 |
| 3MAC-PLA | 18 | 2 | 0 | 3 |
| 6MAC-PLA | 18 | 2 | 0 | 6 |

### Example 3—Characterizations of MAC

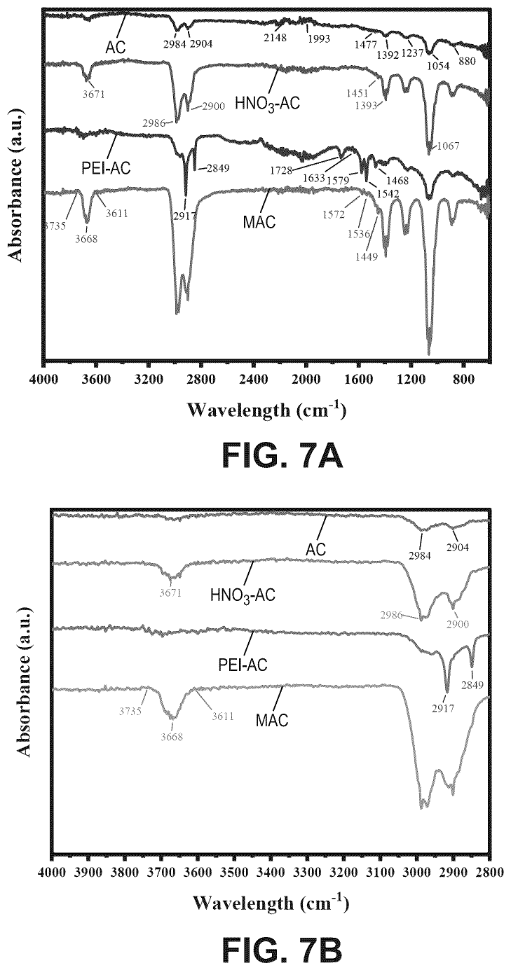

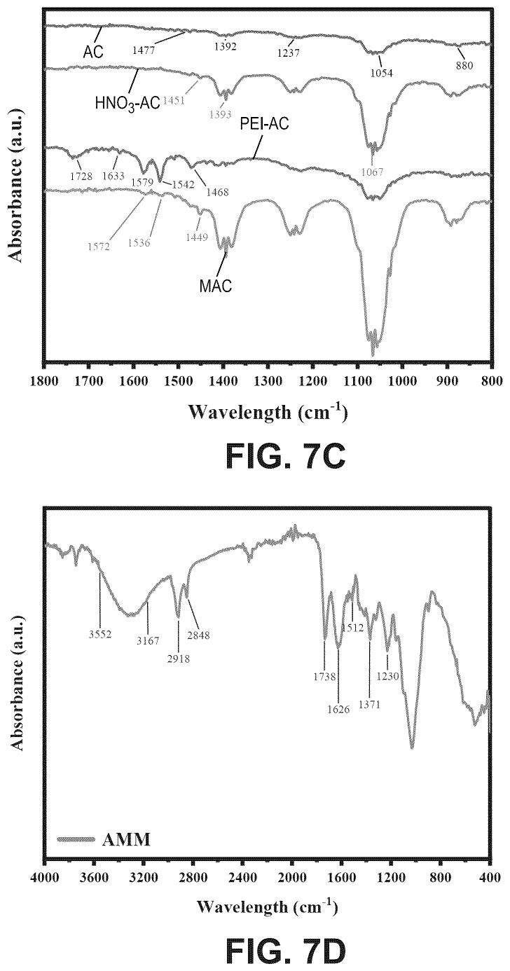

FIG. 7A illustrates Fourier-transform infrared spectroscopy (FT-IR) spectra of AC, HNO₃-AC, PEI-AC, and MAC samples, according to some embodiments. FIG. 7B illustrates Fourier-transform infrared spectroscopy (FT-IR) spectra of AC, HNO₃-AC, PEI-AC, and MAC samples, according to some embodiments. FIG. 7C illustrates Fourier-transform infrared spectroscopy (FT-IR) spectra of AC, HNO₃-AC, PEI-AC, and MAC samples, according to some embodiments.

FT-IR spectroscopy was used to determine the surface chemistry of both the unmodified and functionalized AC powder samples. The characteristic absorption peaks of pure AC were detected at 880 cm⁻¹, 1054 cm⁻¹, 1237 cm⁻¹, 1392 cm⁻¹, 1477 cm⁻¹, 1993 cm⁻¹, 2148 cm⁻¹, 2904 cm⁻¹, and 2984 cm⁻¹, reflecting the C—H stretching vibration, asymmetric stretching vibration of C—O—C, C—O aliphatic ether stretching, C—OH stretching vibration, C═C skeleton vibration, allene C═C═C stretching, carbodiimide N═C═N stretching, and symmetric and asymmetric stretching of an alkane functional group C—H, respectively. Upon nitric acid treatment of the AC particles, the amount of acidic functional groups increased, reflected through the intensification of their respective absorption bands at 3671 cm⁻¹ (alcohol, O—H), 2986 cm⁻¹ (carboxylic acid, O—H), 2900 cm⁻¹ (carboxylic acid, C—OH), 1393 cm⁻¹ (bending vibration of the nitro group, N—O), 1451 cm⁻¹ (stretching vibration of the nitro group, N—O), and 1067 cm⁻¹ (ether groups, C—O—C). The PEI modified AC (PEI-AC) FT-IR spectrum exhibited a shift in peaks at 2917 and 2849 cm⁻¹, indicating the symmetric and asymmetric C—H vibrations of the fatty CH₂ on the PEI backbone. Besides, the peaks at 1633 cm⁻¹, 1579 cm⁻¹, and 1542 cm⁻¹ are the contribution of N—H stretching vibrations of amines in PEI. The peak at 1468 cm⁻¹ can be assigned to C—N stretching vibration, while the peak at 1728 cm⁻¹ confirms the presence of C═N stretching vibration, indicating a successful PEI functionalization of AC.

FIG. 7D illustrates Fourier-transform infrared spectroscopy (FT-IR) spectra of AMM samples, according to some embodiments. A broad peak is shown in the region of 3552-3167 cm⁻¹, which is attributed to the stretching vibrations of NH present in primary and secondary amines and the phenolic/alcoholic/carboxylic hydroxyl groups (C—OH). Additionally, it can be related to the hydroxyl groups in carbohydrates, such as cellulose and hemicellulose, which are the main components of plant cell walls. The highest points at 2918 cm⁻¹ and 2848 cm⁻¹ may be assigned to the alkyl group with a stretching vibration of C—H or to the presence of C═C═0 vibrations. The bands around 1738 cm⁻¹, 1626 cm⁻¹, and 1512 cm⁻¹ correspond to the C═O stretching vibration of the carbonyl groups in lipids and proteins, C═C stretching of the alkenyl groups, and the N—H bending vibration of the amide groups in proteins or the aromatic ring stretching vibration of the lignin, respectively. Also, C—H bending vibrations of the lignin and C—O stretching vibration of carbohydrates of aromatic compounds was observed at 1371 cm⁻¹ and 1230 cm⁻¹.

Similarly, the MAC composite exhibited peaks found in PEI-AC and AMM with a slight shift in C—N stretching vibration from 1468 cm⁻¹ to 1449 cm⁻¹ and a shift in the primary and secondary amines (1572 cm⁻¹ and 1536 cm⁻¹) present in PEI-AC, indicating a strong interaction that occurred between the amine groups of PEI/AC and the hydroxyl groups in AMM. Furthermore, a decrease in intensity and shift in the —OH peak from 3307.5 cm⁻¹ in AMM to 3668 cm⁻¹ in MAC further supports the cross-linking of PEI with AMM. The intensities of the absorption bands increased, indicating an increase in the number of functional groups present in MAC. A broad stretching vibration broadening peak of phenolic hydroxyl or alcoholic hydroxyl groups (C—OH) was observed at 3735-3611 cm⁻¹ for all powder samples.

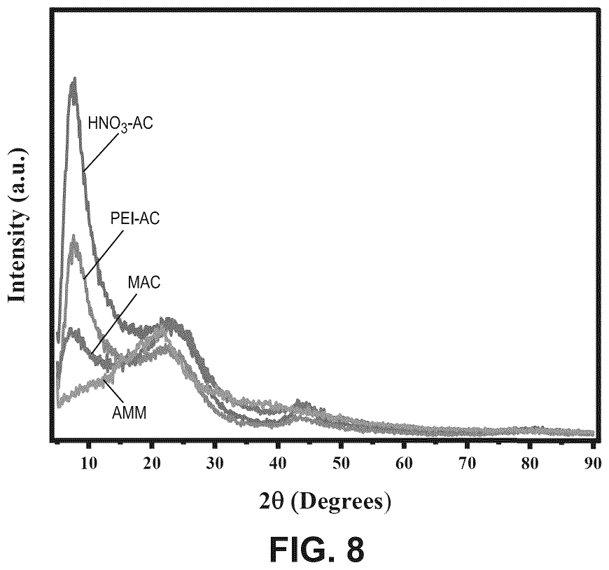

The crystallinity of the control and modified AC samples was investigated using XRD spectroscopy. FIG. 8 illustrates X-ray powder diffraction (XRD) spectra of HNO₃-AC, PEI-AC, MAC, and AMM powder samples, according to some embodiments. Activated carbon is typically amorphous, lacking long-range ordered structure, yet it was possible to observe broad XRD peaks. For the AC treated with HNO₃, three broad peaks were detected, two of which were the characteristic peaks of the unmodified AC, namely, 2θ=23°, 45° corresponding to the (002) and (101) diffraction planes of graphite nanocrystallines. The peak appearing at 2θ=8° can be ascribed to the (001) plane of graphitic oxide which might have formed due to significant oxidation of the AC surface upon nitric acid treatment. The PEI functionalized AC exhibited an analogous set of peaks appearing at 2θ=8°, 22°, 43° reflecting the (001), (002), and (101) planes, respectively. Successful loading of PEI was observed by weakening of the diffraction peaks, which also might have been caused by an increase in the defect density and decreased crystallinity. The XRD pattern of the AMM leaves presented a single broad peak around 2θ=22° attributed to the amorphous or poorly crystalline nature of the organic components in the leaves. For the MAC composite, all three characteristic peaks at 2θ=70, 23°, 44° were detected, yet the AMM distinctive peak at 20=22° overlapped the (002) plane in AC, resulting in an intensified peak at 2θ=23°. The intensity around 2θ=7° decreased, indicating a disturbance of the ordered graphitic layer formed during PEI polymerization on the surface of AC. Therefore, this confirms the composite formed between PEI-AC and AMM particles.

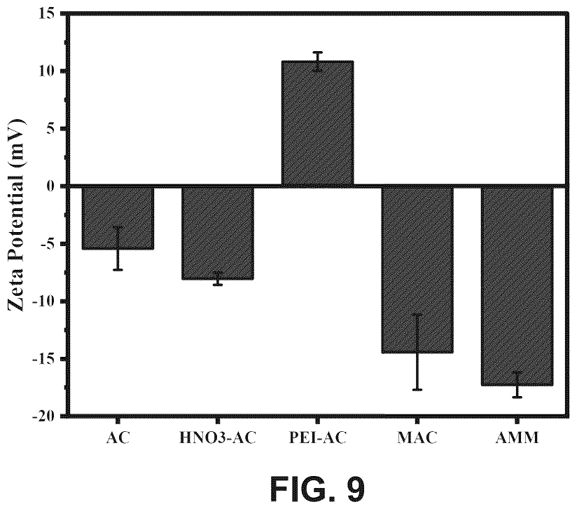

FIG. 9 illustrates zeta (3) values of unmodified AC, AMM, and post treatment and functionalization to get HNO₃-AC, PEI-AC, and MAC, according to some embodiments. Changes in surface charge were examined through the ζ-values shown. For the unmodified AC, the ζ-value was −5.4 mV attributed to the ionized negatively charged oxygen-containing functional groups on the surface of the particle, namely, hydroxyls, carboxyls, phenols, lactones, and ketones. For HNO₃-AC, the ζ-value further decreased to −8.0 mV corresponding to the increase in the number of carboxylic acid, and nitro groups that ionize to give negatively charged surface sites. The functionalization of AC with PEI introduced positively charged sites such as the amine group (—NH or —NH₂), resulting in a positive ζ-value of 10.8 mV. The mangrove AMM sample reflected a negative ζ-value of −17.3 mV since this material is rich in carboxylic acids, phenols, and amine groups. The composite (MAC) including AMM cross-linked by PEI-AC surprisingly reported a negative ζ-value of −14.4 mV despite the positive charges on PEI-AC. The positive sites on PEI-AC electrostatically interact with negative sites on the AMM forming the MAC composite, therefore, allowing oxygen-containing functional groups to dominate.

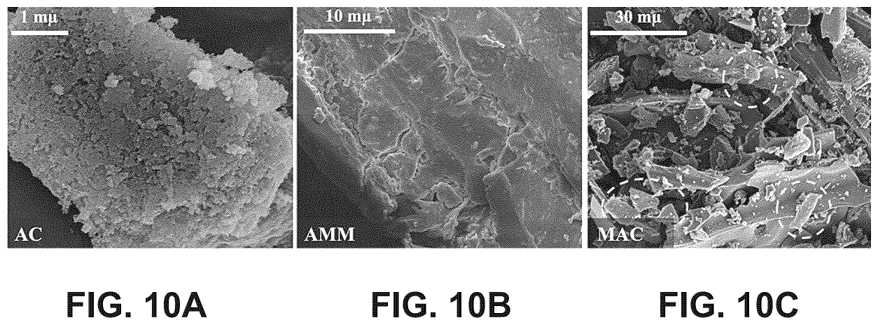

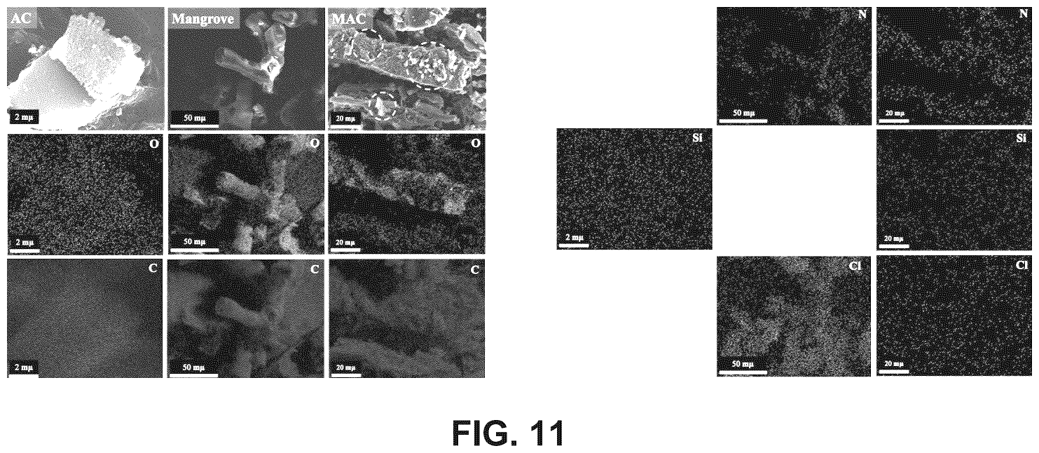

FIG. 10A illustrates a scanning electron microscope (SEM) image of unmodified AC, according to some embodiments. FIG. 10B illustrates a scanning electron microscope (SEM) image of pulverized AMM, according to some embodiments. FIG. 10C illustrates a scanning electron microscope (SEM) image of MAC particles, according to some embodiments. FIG. 11 illustrates energy dispersive spectroscopy (EDS) elemental mapping of AC, AMM, and MAC composite, according to some embodiments. The AC is composed of thin, irregularly shaped flakes that are layered on top of each other to form larger agglomerates. As shown by the EDS mapping of AC, carbon makes up at least 90% by weight of its composition. Other trace elements were also present, including oxygen (7.5%), silicon (0.2%) and potassium (0.14%). Furthermore, the AMM exhibited a rod-like particle of a smooth and unified surface. The EDS mapping confirms the presence of elements such as carbon (C), oxygen (O), and nitrogen (N). Sodium (Na), chloride (CI), magnesium (Mg), potassium (K), and calcium (Ca) were detected at lower concentrations, which are important for mangrove photosynthesis, respiration, and other physiological processes. The MAC shows AC agglomerates deposited onto the rod-like shaped AMM, where the corresponding elemental mapping supports this claim. The increase in C from 48% to 84% and the detection of trace salts confirm the formation of the MAC composite. The elemental percentages are summarized in Table 2.

TABLE 2
Elemental percentages of AC, AMM, and MAC.

| | Weight (%) | | |
|---|---|---|---|
| Element | AC | AMM | MAC |
| O | 7.48 | 44.97 | 11.24 |
| C | 92.18 | 47.93 | 84.12 |
| N | — | 2.21 | 2.88 |
| Si | 0.20 | — | 0.32 |
| Cl | — | 1.02 | 0.44 |
| Na | — | 2.27 | 0.33 |
| K | 0.14 | 0.56 | 0.20 |
| Ca | — | 0.43 | 0.32 |
| Mg | — | 0.59 | 0.15 |

### Example 4—Characterizations of MAC-Based PLA Composite Membranes

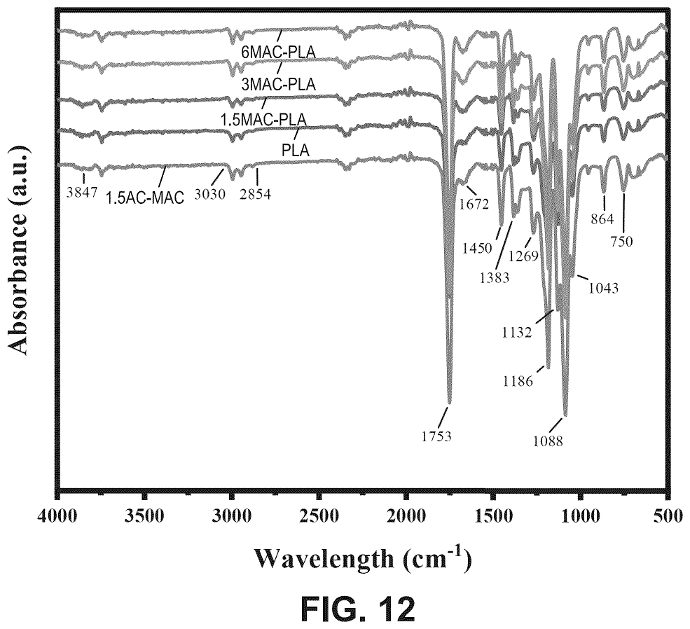

FT-IR spectroscopy was used to investigate the surface functional chemical groups of MAC-based PLA of the prepared blended films. FIG. 12 illustrates FT-IR spectra of (unmodified/control) PLA and MAC-PLA composite membranes, according to some embodiments. FIG. 12 shows the FT-IR spectra of PLA, 1.5AC-PLA, 1.5MAC-PLA, 3MAC-PLA, and 6MAC-PLA. For all samples, the main characteristic bands corresponding to PLA groups were detected at approximately similar wavelengths. The FT-IR spectrum of the unmodified membrane (PLA) exhibited characteristic peaks at 3029-2854 cm⁻¹, 1753 cm⁻¹, 1450 cm⁻¹, and 1383 cm⁻¹, confirming the presence of the C—H stretching vibration of CH₃, C═O of the carbonyl (ester) group, and asymmetric and symmetric bending vibrations of the methyl group. The bands at 1186 cm⁻¹ and the three bands at 1132 cm⁻¹, 1088 cm⁻¹, and 1043 cm⁻¹ are assigned to the stretching vibration of —C—O— in CH—O— and in CO—O groups in PLA chains, respectively. The weak bands at 862 cm⁻¹ and 750 cm⁻¹ are assigned to the amorphous and crystalline phases of PLA, respectively. Increasing the blended concentration from 0 wt. % to 6 wt. % resulted in peak intensification at 1672 cm⁻¹, 1269 cm⁻¹, 1088 cm⁻¹, 864 cm⁻¹, and 750 cm⁻¹ which may be accredited to the N—H amine stretching vibration, C—OH stretching vibration or C—O stretching vibration of the aromatic compounds, C—H stretching vibration, and the stretching of aromatic rings present in the structure of MAC. A broad peak corresponding to the hydroxyl group appeared at around 3847 cm⁻¹.

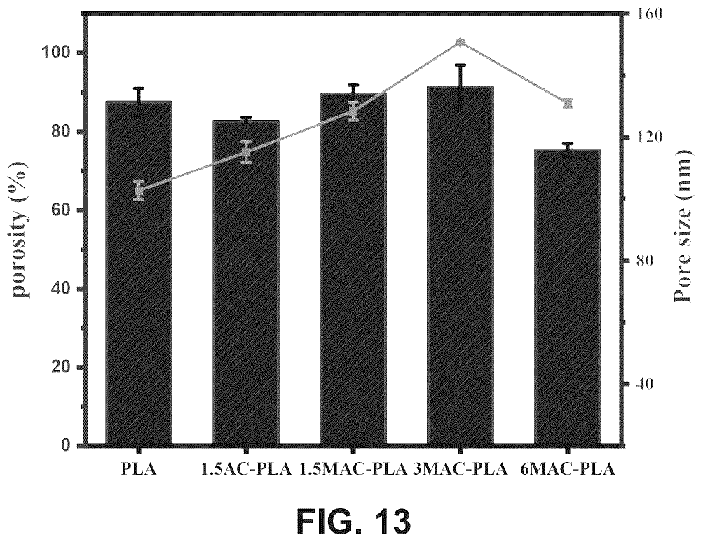

FIG. 13 illustrates porosity and mean pore radius of PLA and MAC-PLA composites with 1.5, 3, and 6 wt. % of MAC, according to some embodiments. The ε (porosity) and rₘ (pore size) were altered to some extent after different loading of MAC in the range of 1.5 to 6 wt. % in the PLA membrane. An increase in porosity from 87.5±3.5% to 89.6±2.2% was observed upon the incorporation of 3 wt. % of MAC, as compared to PLA. The largest pore size was allocated to 3MAC-PLA with an rₘ of 150.76±0.53 nm, reflecting a 46.8% increase. The rₘ trend continued to decrease, reaching a value of 130.99±1.31 nm after 6 wt. % loading of MAC, yet it remained higher than that of the unmodified membrane (102.69±2.91 nm). An analogous trend was observed for the pore size measured using a porometer, where the pore diameter increased from 0.241 μm (PLA) to a maximum of 0.407 μm (1.5MAC-PLA). Then it further decreased to 0.291 μm (6MAC-PLA). Yet, the highest total pore number and total pore area were acquired by 3MAC-PLA with a value of 1.35×10⁹ and 2.22×10⁷ μm², respectively, explaining the porosity trend observed by the gravimetric method. A summary of the pore size of various membranes is provided in Table 3.

TABLE 3
Summary of the pore size of various membranes.

| | Smallest | Mean | Mean | | | Total | |
|---|---|---|---|---|---|---|---|
| | pore | free | pore | Total | Total | pore | Calculated |
| | size | path | diameter | pore | pore area | area | permeability |
| Sample | (μm) | (μm) | (μm) | number | (μm²) | (%) | (Darcy) |
| PLA | 0.1066 | 0.1371 | 0.2414 | 1.348 × 10⁹ | 1.877 × 10⁷ | 22.98 | 0.0008055 |
| 1.5AC-PLA | 0.1909 | 0.2722 | 0.2759 | 2.551 × 10⁸ | 1.437 × 10⁷ | 17.58 | 0.001437 |
| 1.5MAC-PLA | 0.2475 | 0.3196 | 0.4069 | 1.347 × 10⁸ | 9.982 × 10⁶ | 12.22 | 0.001187 |
| 3MAC-PLA | 0.1219 | 0.1396 | 0.1737 | 1.349 × 10⁹ | 2.218 × 10⁷ | 27.15 | 0.001020 |
| 6MAC-PLA | 0.1259 | 0.2854 | 0.2910 | 3.724 × 10⁸ | 1.901 × 10⁷ | 23.26 | 0.001798 |

Surface hydroxyls and amine groups present in MAC can induce hydrophilic behavior in the polymer solution, impacting the exchange rate between the DMAc solvent and the non-solvent (water) during phase inversion. A selective thick top-layer with relatively small pore sizes could develop from a lower exchange rate between DMAc and water caused by the increased viscosity of the blended solutions after loading. Particle agglomeration at higher MAC loading can induce undesirable defects within the matrix that act as new interfacial channels for the transport of water molecules and thus affect the overall porosity of the respective membranes. It was noticed that ε and rₘ values slightly decreased and increased in 6MAC-PLA, respectively. The high loading of filler can result in the occupation of void spaces between the polymer chains creating more tortuous paths for fluid flow. Furthermore, the increase in particle agglomerates will form new internal defects and interstitial voids.

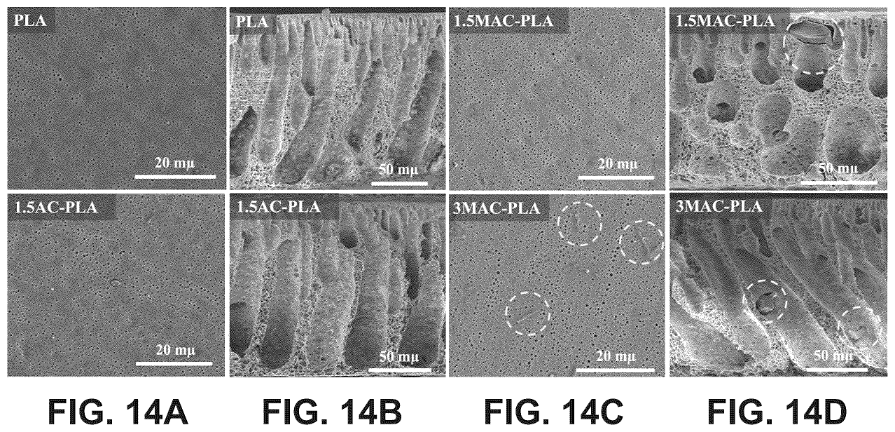

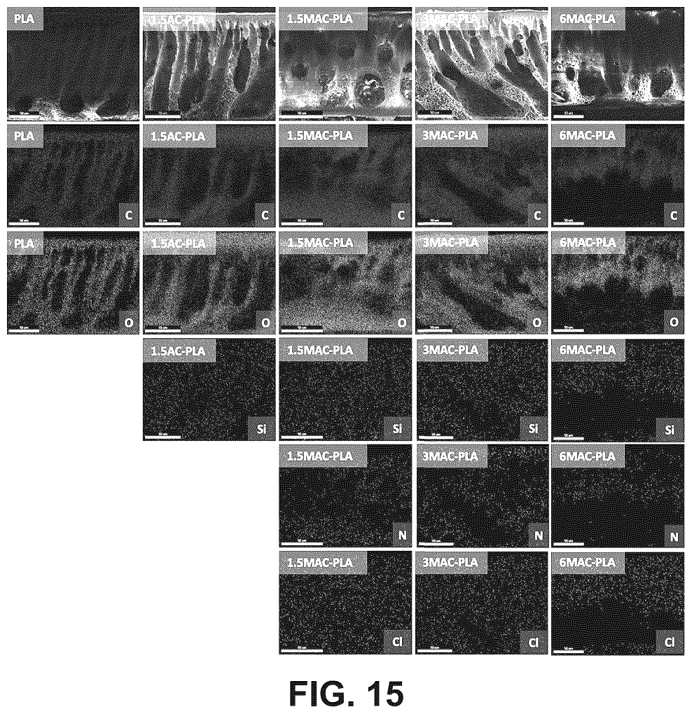

FIG. 14A illustrates SEM images of the top surface of PLA membranes, according to some embodiments. FIG. 14B illustrates cross-sectional SEM images of PLA membranes, according to some embodiments. FIG. 14C illustrates SEM images of the top surface of PLA membranes, according to some embodiments. FIG. 14D illustrates cross-sectional SEM images of PLA membranes, according to some embodiments. The unmodified PLA and modified membranes have a typical asymmetric morphology with a top skin layer and porous sublayers consisting of finger-like pores. The pores are evident on the top surface of the respective membranes (FIG. 14A and FIG. 14C), where the MAC particles were detected in 3MAC-PLA, and 6MAC-PLA (circled). Cross-sectional SEM images of the unmodified and composite PLA membranes demonstrated the porous sublayer with either finger-like or macro void morphology (FIG. 14B and FIG. 14D). The transition from finger-like sublayer in PLA to macro void sublayer in 1.5MAC-PLA can be associated with the low viscosity of the solution used to make MAC. Low-viscosity solutions are more prone to macro-void formation due to the higher mobility and diffusion of the polymer chains during the casting process. On the contrary, 3MAC-PLA exhibited a selective top-layer barrier of a typical finger-like porous sublayer, which started with a tight structure on the surface and gradually became more porous as it extended through the thickness of the membrane. Overall, the fabricated membranes have relatively small pores, as per the top surface analysis, and finger-like pores in the porous sublayers for up to 3 wt. % loading of the filler.

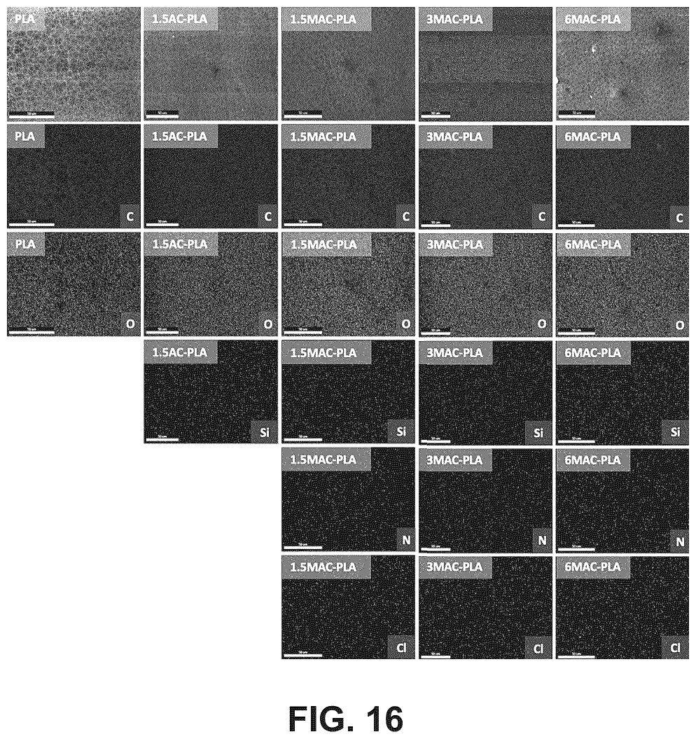

FIG. 15 illustrates EDS mapping of membrane top surface, according to some embodiments. FIG. 16 illustrates EDS mapping of C, O, Si, N, and Cl on cross-section images of various membranes, according to some embodiments. EDS analysis of the composite membranes was performed to confirm the presence and homogeneous dispersion of MAC particles within the PLA membrane matrix, where elemental C, O, Si, N, and Cl were detected, as shown in FIG. 15 and FIG. 16. Also, elements such as C, O, and S were detected because they make up the structure of the unmodified PES polymer.

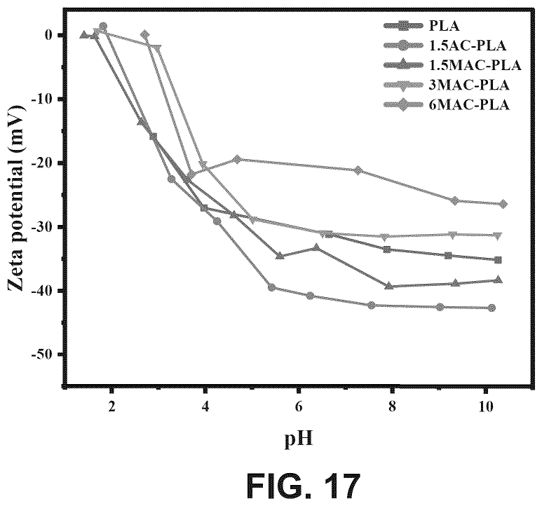

FIG. 17 illustrates zeta (3) value of unmodified PLA, 1.5AC-PLA, 1.5MAC-PLA, 3MAC-PLA, and 6MAC-PLA membranes, according to some embodiments. The surface charge of the modified membranes at various filler types and loading was estimated from the respective zeta potential value in the pH range of 2 to 10. All membranes exhibited a similar trend, where the negativity of the membrane surface increased with pH. The protonation and deprotonation of functional groups at acidic and basic pH, respectively, explain this trend. At neutral pH, the PLA membrane displayed a ζ-value of −31.7 mV, which further decreased to −35 mV at pH 10, due to the deprotonation of the carboxylic acid groups present within its backbone structure. Blending 1.5 wt. % of AC (1.5AC-PLA) reflected a ζ-value of −42.5 mV at pH 7, due to the presence of a higher number of carboxyl groups. Increasing the pH from 7 to 10 resulted in a less steep drop in ζ, with a ζ-value of −42.7 mV at basic pH. The small change in the zeta potential with changes in ionic strength in 1.5AC-PLA can be ascribed to the low concentration of the filler.

Composite membranes fabricated using MAC as a filler with a load ranging from 1.5 wt. % to 6 wt. %, surprisingly, demonstrated a less negative membrane at all pH values. Despite the negativity of the MAC particles (−14.4 mV), blending it within the PLA polymeric matrix reduced the overall surface negativity of the membrane. This is explained by the local concentration of negative charges formed by negative fillers that are close to the membrane surface. Such negative sites can attract positive ions from the surrounding solution and neutralize some of the negative surface charges. Furthermore, fillers can induce changes in the conformation or orientation of polymer chains on the membrane surface, leading to alterations in the surface charge distribution. This claim is supported by the presence of MAC particles at the membrane top-surface of 3MAC-PLA and 6MAC-PLA (FIG. 14A and FIG. 14C). At pH 7 the respective I-values for the MAC composites were-35.6 mV (1.5 wt. % MAC), −31.1 mV (3 wt. % MAC), and −21.1 mV (6 wt. % MAC).

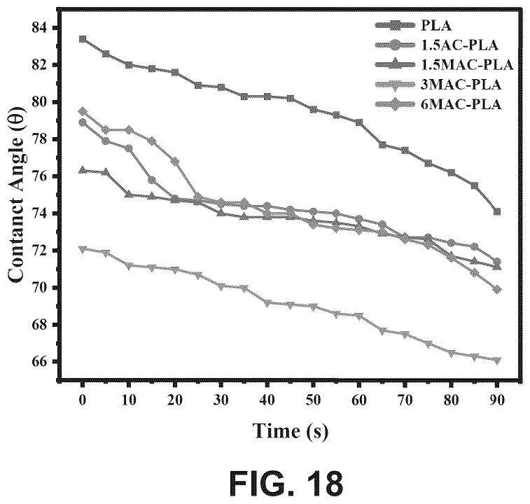

FIG. 18 illustrates dynamic water contact angle measurement of unmodified PLA and MAC composites, according to some embodiments. The wettability of the membrane surface was assessed by the water contact angle (CA). FIG. 18 presents the dynamic CA measurements collected within a 90 second interval for the unmodified PLA and composite membranes. As a hydrophobic polymer, the PLA membrane exhibited the highest static CA values of 83.4° (0 s) and 74.1 (90 s), respectively. Furthermore, 1.5AC-PLA reflected an enhanced hydrophilic surface with a static CA value that started at 78.9° and ended at 71.4° by the end of the collection interval. This can be explained by the synergistic effect of a larger pore size and negative surface charges, which increase the surface area and interactions with water, resulting in a lower contact angle. Furthermore, the presence of functional groups such as —NH, —NH₂, and —OH on the surface and within the membrane matrix may alter the contact angle. These functional groups are considered water-holding moieties that can rapidly absorb water molecules via dipole-dipole and ion-dipole interactions. The 0^{th} sec static CA further decreased to 76.3° and 72.1° for the MAC composites with the lowest loadings of 1.5 wt. % and 3 wt. %, respectively. The hydrophilic properties of 1.5MAC-PLA and 3MAC-PLA can be associated with the incremental increase in porosity due to a more porous surface providing more sites for the water to penetrate and spread on the surface, leading to a larger contact area and a lower contact angle. However, as the loading percentage increased to 6 wt. %, the contact angle began to increase, indicating a more hydrophobic behavior. This can be explained by the fact that the membrane had reduced porosity and surface charges, which all contributed to a less wettable surface. The static CA of 6MAC-PLA decreased from 97.5° to 69.9°, yet remained more hydrophilic compared to unmodified PLA. In general, the combination of porosity, pore size, and surface charges had a significant effect on the wettability of the membrane surface.

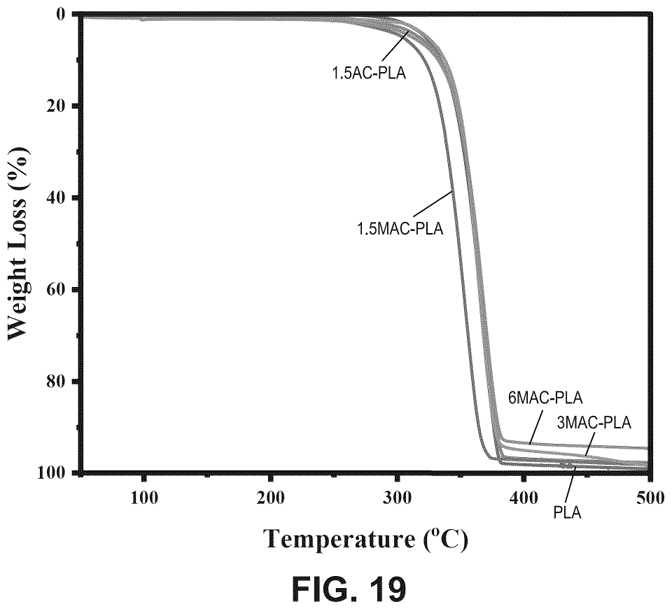

FIG. 19 illustrates weight loss of various membranes at various temperatures, according to some embodiments. FIG. 19 presents the initial, main and char decomposition regions in the thermogravimetric analysis (TGA) curves. All membranes exhibited a three-stage weight loss profile in the examined temperature region of 50° C. to 500° C. The first stage involved the elimination of water (T<100° C.), which was driven off from the polymer chains. The second stage involved the thermal fracture of the molecular chains. The third and last stage involved the degradation of PLA and PVP into volatile compounds and carbon char by thermal scission of adjacent C—O bonds. The weight loss and the slope of decomposition gradually reduced as the MAC content increased from 1.5 wt. % to 6 wt. %. Additional reinforcement and higher thermal stability are due to the strong interactions between PLA polymer chains and MAC fillers. The weight loss % of PLA and 6MAC-PLA at 500° C. were 99.1% and 94.6%, respectively.

### Example 5—Filtration

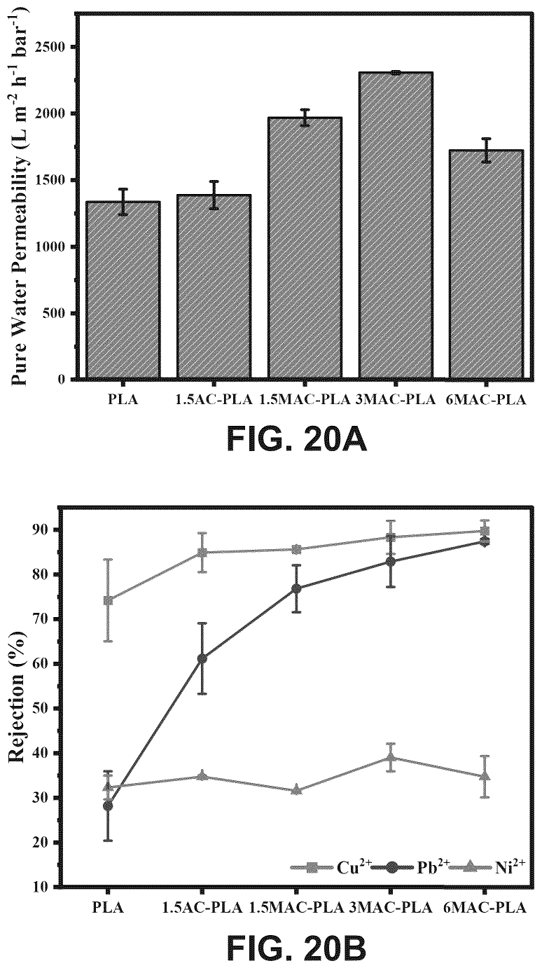

FIG. 20A illustrates pure water permeabilities (PWP) of various membranes, according to some embodiments. The unmodified PLA reported the lowest PWP as low as 1336.4±96.4 L·m⁻²·h⁻¹ bar⁻¹. This increased to 2306.6±9.7 L·m⁻²·h⁻¹ bar⁻¹ in the 3MAC-PLA membrane and then further decreased to 1722.5±87.6 L·m⁻²·h⁻¹ bar⁻¹ in 6MAC-PLA. The findings are consistent with the patterns observed in porosity, average pore size, and contact angle in previous observations. The increase in PWP can be attributed to the combined influence of better hydrophilicity, mean pore size, and porosity of the composite membranes relative to the original PLA membrane.

FIG. 20B illustrates heavy metal rejections of various membranes at pH 7, according to some embodiments. The selectivity of the membranes against a synthetic solution (25 ppm) composed of the bivalent heavy metal ions Pb²⁺, Cu₂₊, and Ni²⁺ at neutral pH is shown in FIG. 20B. The most significant increase in rejection was observed for Pb²⁺ ions, where it increased from 28.2±7.8% in PLA to 87.4±0.6% in 6MAC-PLA. A similar trend was observed for Cu²⁺ ions where it increased from 74.2±9.2% to 89.8±2.4% for PLA and 6MAC-PLA, respectively. Furthermore, the rejection of Ni²⁺ ions showed a gradual increase, reaching a maximum of 39.1±3.1% for 3MAC-PLA. The overall increase in selectivity depended on the increase in the functional groups present at the membrane surface upon filler blending (FIG. 14A and FIG. 14C). For example, positively charged protonated primary and secondary amine groups can electrostatically repel heavy-metal ions. In contrast, the heavy metal ions can be attracted to negatively charged deprotonated phenolic groups, resulting in surface adsorption and metal complexation. These results coincide with the previous observation of the & trend, which showed that the membrane surface became less negative as the density of amine groups increased, from −31.7 mV for PLA to −21.1 mV for 6MAC-PLA. The inner sphere complexation reactions are shown in Equations 1-3:

X−OH+M²+→(X−O−M)⁺+H⁺ (1)

X−O⁻+M²⁺→(X−O−M)⁺ (2)

X−OH+M²⁺+H₂O→X−OMOH+2H⁺ (3)

where X refers to the MAC particles present on the surface of the PLA membrane and —OH and —O come from the C atoms on the MAC composite material.

The hydrated ionic radii, solubility, and affinity of the heavy metal ions towards the surface functional groups explain the discrepancies in the rejection between Pb²⁺ and Cu²⁺ against Ni²⁺ ions. Despite the fixed experimental conditions, the MAC-PLA (1.5, 3 and 6 wt. %) composites had a higher removal rate of Pb²⁺ and Cu²⁺ compared to Ni²⁺ ions. This can be explained by the higher affinity of MAC towards metals of smaller hydrolysis constant values and the formation of insoluble metal hydroxides at pH 7. The values are 9.86, 8.1, and 7.7 for Ni²⁺, Cu²⁺, and Pb²⁺, respectively. The hydrated ionic radii of the metal ions are ranked as follows: Pb²⁺>Cu²⁺>Ni²⁺. This can also explain the observed trend in FIG. 20B. Therefore, the metal removal mechanism was based on ion exchange, adsorption, and electrostatic interaction between the adsorbent and the adsorbate. The expected hydrolysis reaction is presented in Equation 4:

M²⁺+xH₂O→[M(OH)_{X}(H₂O)_{Y}]^{(n-X)}+xH+ (4)

where M is the metal ion and x and y are the stoichiometric coefficients of the water molecules and hydroxide ions, respectively.

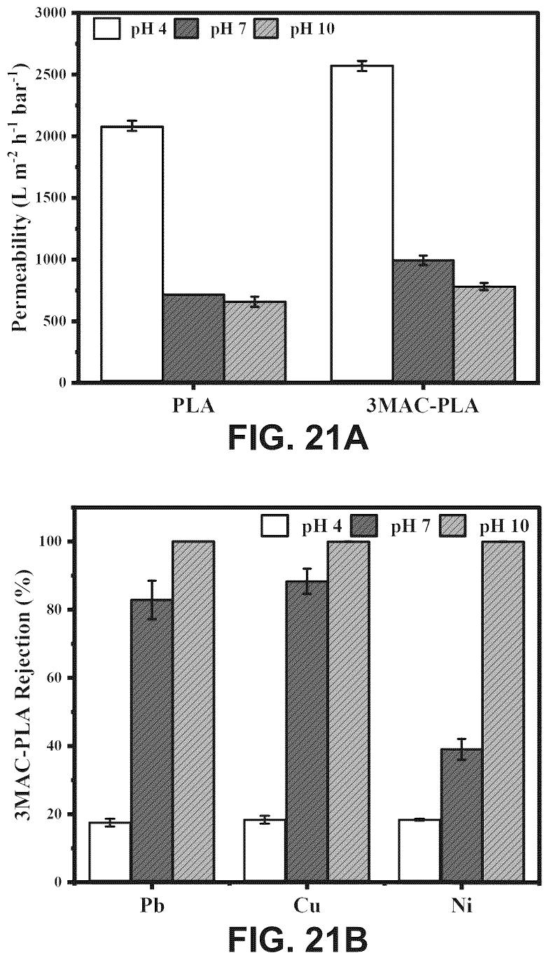

FIG. 21A illustrates the pH effect on water permeability of various membranes, according to some embodiments. The pure water permeability (J) was calculated using Equation 5. The effect of pH on the Jₘᵢₓ and rejection of PLA and 3MAC-PLA membranes was observed at three conditions (pH: 4, 7, and 10), extreme acidity, neutrality, and extreme basicity. The trends of Jₘᵢₓ in PLA and 3MAC-PLA were relatively similar. Using a synthetic metal mixture as feed caused a drastic decrease in Jₘᵢₓ from 2077.5±49.1 to 657.1±41.2 L·m⁻²·h⁻¹·bar⁻¹ for PLA, and from 2569.6=37.5 to 780.8±29.7 L·m⁻²·h⁻¹ bar⁻¹ for 3MAC-PLA, respectively. Under extreme basic conditions, metal ions may form insoluble metal hydroxide particles. Such particles accumulate at the membrane surface and clog the pores, causing a decrease in Jₘᵢₓ and an increase in rejection. Jₘᵢₓ may be calculated using Equation 5.

$$PWP = \frac{V}{A \times Δ t \times Δ p} \qquad ( 5 )$$

where V=volume, A=surface area, t=time, and p=pressure.

FIG. 21B illustrates the pH effect on heavy metal rejection of various membranes, according to some embodiments. In FIG. 21B, the rejection against Pb²⁺, Cu²⁺, and Ni²⁺ was optimal at pH 10, with the values of 100%, 99.95%, and 99.95% for 3MAC-PLA, respectively. Almost 100% removal is attributed to the negatively charged sites of phenolic groups in MAC, which will electrostatically absorb the metal ions. Furthermore, under such extreme basic conditions, metal ions exceed their solubility, forming insoluble metal hydroxide precipitates, namely, Cu(OH)₂, Pb(OH)₂, and Ni(OH)₂. At low PH levels, the metal ions form metal-hydrogen ion complexes, which are smaller in size than the metal ions alone.

As a result of the decrease in the hydration size of the metal ions, the selectivity of the membrane is depleted and the Jₘᵢₓ restored its maximum value. This is clearly observed in FIG. 21B, where rejections were 17.3±0.9% (Pb²⁺), 18.2±1.3% (Cu²⁺), and 17.5±0.1% (Ni²⁺) for 3MAC-PLA. Also, the ζ trend explains the observations made here. At pH 4 the positive charges on the membrane surface become more pronounced as the amine groups get protonated to give —NH₄⁺ sites, and the phenolic groups are partially ionized to give phenoxide ion sites —O⁻. The limited number of negatively charged sites on the membrane is likely to attract positively charged metal ions, which is why the metal ions are partially blocked at pH 4. At pH 4, the H⁺ ions will dominate; therefore, they compete with the metal ions to adsorb onto the negative sites on the membrane surface, leading to a reduction of metal uptakes. The rejection value may be calculated using Equation 6.

$${R}_{i} ( \% ) = \frac{{c}_{f eed , i}^{o} - {c}_{permeate , i}^{t}}{{c}_{feed , i}^{o}} \times 100 , where i = {Cu}^{2 +} , {Ni}^{2 +} , {Pb}^{2 +} \qquad ( 6 )$$

where C_{feed,i}^{o}=heavy metal ionic concentrations in the feed and C_{permeate,i}^{t}=heavy metal ionic concentrations in the permeate.

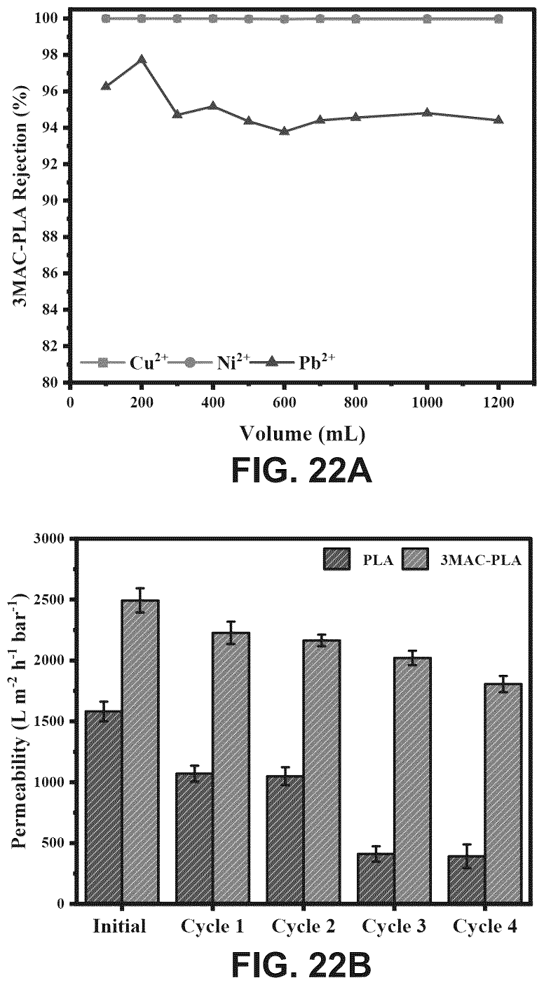

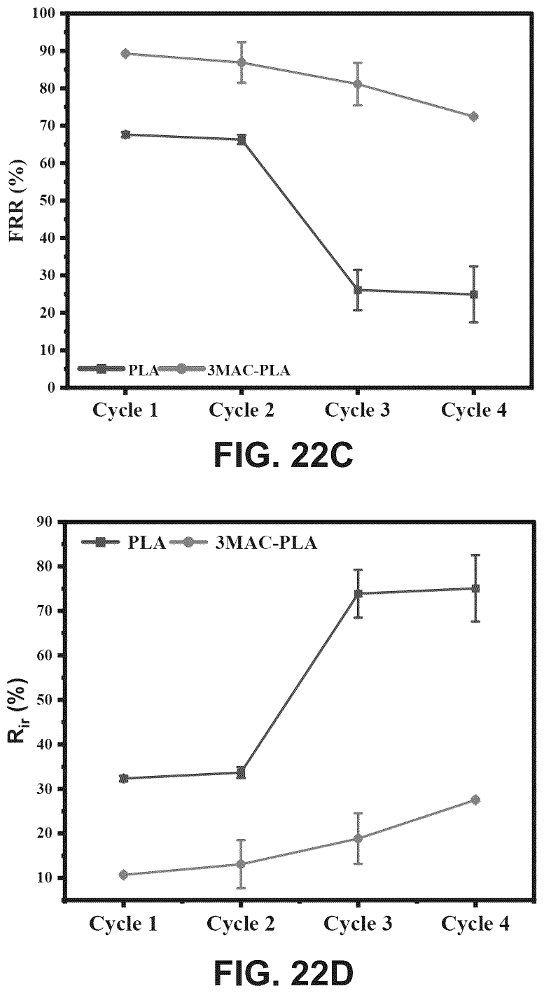

FIG. 22A illustrates durability testing of 3MAC-PLA, according to some embodiments. To examine the potential of these composite membranes in terms of heavy metal ion removal, a volume-basis long-term study was performed. A volume of 1200 mL of the synthetic heavy metal mixture (pH 10) was filtered through the 3MAC-PLA membrane to observe the rejection trend versus the permeate volume. In FIG. 22A, the rejection of 3MAC-PLA against Cu²⁺ and Ni²⁺ was maintained above 98% throughout the evaluation period, whilst it dropped to 94.4% for Pb²⁺ at the end of the filtration process. The pC-pH diagram of the metal hydroxides can explain this behavior. At pH 10 both soluble and insoluble metal hydroxides can co-exist, namely, M(OH)₂, M(OH)₃⁻, M(OH)₄²⁻, and M(OH)⁺ where M is either Cu, Pb, or Ni. However, Pb²⁺ hydroxide species can also be present in the form of Pb₆(OH)₂⁴⁺, which are adsorbed at the negatively charged active sites on the membrane surface. Upon saturation of Pb²⁺ at the membrane surface, a concentration gradient can be formed across the membrane allowing lead species to flow towards the permeate side, hence, lowering its rejection over time. Also, the positive species can easily flow or adsorb on the negatively charged pores upon the deprotonation of the phenolic groups. However, the excess of negatively charged Cu²⁺ hydroxides and Ni²⁺ hydroxides enhances rejection through electrostatic repulsive forces.

FIG. 22B illustrates cyclic permeability results of various membranes, according to some embodiments. FIG. 22C illustrates flux recovery ratio (FRR) results for various membranes, according to some embodiments. FRR may be calculated using Equation 7. FIG. 22D illustrates irreversible fouling ratios (Rᵢᵢᵣ) of various membranes, according to some embodiments. Rᵢᵢᵣ may be calculated using Equation 8. The anti-fouling property of composite membranes was investigated by evaluating the reusability and recyclability of unmodified PLA and 3MAC-PLA by acid cleaning at pH 4 and 4 cycles of operation with a heavy metal mixture (25 ppm). The anti-fouling properties of composite membranes were determined by measuring their water permeability (J_{wi}) and irreversible fouling ratio (Rᵢᵣ) after cleaning, which is critical for ensuring their durability, maintenance cost, and lifespan. The results summarized in FIG. 22B-22D indicated that the 3MAC-PLA membrane maintained high permeability and flux recovery after 4 cycles of alternating adsorption and desorption processes. 3MAC-PLA recovered 72.4±0.3% of its initial PWP after 4 cycles, while PLA recovered only 24.9±7.5% of its initial PWP. The PWP at the end of the 4th cycle reached a value of 1806.2±66.6 L·m⁻²·h⁻¹·bar⁻¹ and 391.2±97.9 L·m⁻²·h⁻¹ bar⁻¹ for 3MAC-PLA, and PLA, respectively. The slow reduction in PWP seen in 3MAC-PLA could be attributed to insufficient removal during membrane cleaning or prolonged attachment of heavy metal ions to the membrane surface. The Rᵢᵣ presented in FIG. 22D confirmed this observation. The irreversible fouling ratio was the highest for PLA, where it increased sharply from 32.34±0.64 to 75.1±7.5%. Rather, a gradual increase was detected for 3MAC-PLA, increasing from 10.7±0.01 to 27.5±0.3% by the end of the 4^{th} desorption cycle. The main reason for the superior performance of the 3MAC-PLA membrane compared to unmodified PLA membrane is the existence of pH-sensitive and water-attracting MAC particles that greatly enhance the hydrophilicity of the composite membrane and the surface charge.

$$FRR ( \% ) = \frac{PWP}{{J}_{w i}} \times 100 , where i = cycle number \qquad ( 7 )$$

$${R}_{irr} ( \% ) = ( \frac{{J}_{w i} - PWP}{{J}_{w i}} ) \times 100 , where i = cycle number \qquad ( 3 )$$

where J_{wi} (L·m⁻²·h⁻¹·bar⁻¹) is the post-cleaning water permeability.

### Example 6-Kinetic Models and Isotherms

The experimental data for the adsorption isotherm was collected at pH 4 and 7 for the 3MAC-PLA membrane when submerged in a 25 ppm synthetic heavy metal mixture. The experiment at the extreme basic condition of pH 10 was eliminated to assure the complete solubility of Cu²⁺, Pb²⁺, and Ni²⁺ ions. Two isotherm models, the Langmuir and Freundlich isotherm models, were used to fit the experimental data. The fitting of experimental data and the summary of isotherm constants are tabulated in Table 4. Freundlich fit the experimental data with a higher correlation coefficient (R²-value) than the Langmuir isotherm for Ni²⁺ ions, suggesting a non-uniform affinity for adsorption on a heterogeneous surface through chemisorption. The parameter n laid between a value of 1 to 10 indicating favorable adsorption. On the contrary, Langmuir better fitted the experimental data at a higher correlation coefficient than the Freundlich isotherm for Pb²⁺ and Cu²⁺ ions, indicating monolayer adsorption on perfectly flat, immobile sites (homogenous surface) of equal adsorption energy. The maximum adsorption capacities at pH 7 are 4.2 mg·g⁻¹ for Cu²⁺, 5.0 mg·g⁻¹ for Ni²⁺, and 6.8 mg·g⁻¹ for Pb²⁺, respectively. This can be explained by the complex formation between M²⁺ (M=Cu, Pb, Ni) and the nitrogen and oxygen-containing groups in the immobilized MAC particles and the surface adsorption of M²⁺ on the negatively charged 3MAC-PLA surface.

TABLE 4
3MAC-PLA Adsorption isotherm parameters for both
Langmuir and Freundlich isotherm at pH 4 and 7.

| | | Langmuir Isotherm Parameters | | | | | | | | | |
|---|---|---|---|---|---|---|---|---|---|---|---|
| | | | | | qₘ | K_{L}* 10³ | Freundlich Isotherm Parameters | | | | |
| | | slope | y-intercept | R² | (mg · g⁻¹) | (L · mg⁻¹) | slope | y-intercept | R² | n | k_{F} |
| pH 4 | Cu²⁺ | 208.81 | 0.59 | 0.292 | 1.7 | 2.82 | 1.46 | −6.79 | 0.644 | 0.59 | 1.00 |
| | Ni²⁺ | 21.98 | 0.31 | 0.799 | 3.2 | 14.17 | 0.87 | −3.00 | 0.857 | 0.31 | 1.01 |
| | Pb²⁺ | 23.70 | 0.26 | 0.849 | 3.9 | 10.77 | 0.91 | −3.12 | 0.892 | 0.26 | 1.01 |
| | Cu²⁺ | 28.76 | 0.24 | 0.968 | 4.2 | 8.26 | 0.89 | −3.24 | 0.961 | 0.24 | 1.01 |
| pH 7 | Ni²⁺ | 29.82 | 0.20 | 0.916 | 5.0 | 6.69 | 1.03 | −3.69 | 0.952 | 0.20 | 1.01 |
| | Pb²⁺ | 4.76 | 0.15 | 0.961 | 6.8 | 30.77 | 0.58 | −0.83 | 0.875 | 0.15 | 1.03 |

Furthermore, the low R²-value observed at pH 4 can be explained by the fact that minimal to zero adsorption of heavy metals occurs under such acidic conditions. The adsorption kinetics were also investigated, where experimental data were fitted against the PFO and PSO kinetic models. As expected, for all three heavy metal ions, the kinetic of adsorption was expressed by chemisorption, where a chemical bond is to be formed between the adsorbate and the adsorbent during the adsorption process. These novel membranes were compared with polymeric membranes, as summarized in Table 5.

TABLE 5
Comparison between different studies utilizing green adsorptive UF membranes
for heavy metal removal.

| | | Adsorption capacity | Flux |
|---|---|---|---|
| Polymeric composite | Conditions | (mg · g⁻¹)/removal (%) | (L · m⁻² · h⁻¹) |
| HAp/PLA | Cᵢₙₜ = 1-10 ppm | Pb²⁺ = 1.7/97% | 1100 |
| | pH = 7 | | |
| CTS-g-PLA nanofibers | Cᵢₙₜ = 50-200 ppm | Co²⁺ = 110 | — |
| | pH = 7 | | |
| PDA/CTS-g-PLA nanofibers | Cᵢₙₜ = 50-200 ppm | Cu²⁺ = 270 | — |
| | pH = 6 | | |
| PLA MPs | Cᵢₙₜ =10-50 ppm | Pb²⁺ = 1.6 | — |
| | pH = 5 | | |
| Polysaccharide-PLA nanofibers | Cᵢₙₜ = 160-1600 ppm | Cu²⁺ = 234 (TCFN/PLA) | — |
| | pH = 6-7.5 | Cu²⁺ = 208 (ChNF/PLA) | |
| PLA MPs | Cᵢₙₜ = 0.2-15 ppm | Cu²⁺ = 1.04 | — |
| | pH = 5.5 | | |
| PAA/sodium alginate | Cᵢₙₜ = 25-800 ppin | Cu²⁺ = 591.7 | 868 |
| | pH = 5.5 | | |
| AC/CTS-PEO fibers | Cᵢₙₜ = 50-300 pput | Cu²⁺ = 195.3 | — |
| | pH = 5.5 | Pb²⁺ = 176.9 | |
| CTS/Cellulose fibers | Cᵢₙₜ = 100-600 ppm | Cu²⁺ = 112.6 | — |
| | pH = 7 | Pb²⁺ = 57.3 | |
| Carboxylated cellulose | Cᵢₙₜ = 30-130 ppm | Pb²⁺ = 81.3/98.2% | — |
| | pH = 5 | | |
| CTS/PEO | Cᵢₙₜ = 50-100 ppm | NP²⁺ = 227.3 | — |
| | pH = 5.5 | | |
| Nylon 66-Sulfhydryl/CTS | Cᵢₙₜ = 20-100 ppm | Ni²⁺ = 97.6% | — |
| | pH = 7 | | |
| 3MAC-PLA | Cᵢₙₜ = 15-65 ppm | Cu²⁺ = 4.2/99.9% | 2306.6 ± 9.7 |
| | pH = 7 | Ni²⁺ = 5/99.9% | |
| | | Pb²⁺ = 6.8/100% | |

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

What is claimed is:

1. A composite polymeric membrane comprising:
polylactic acid polymer; and
an additive component, wherein the additive component includes activated carbon functionalized with polyethylenimine.

2. The membrane of claim 1, wherein the additive component includes phenolic groups.

3. The membrane of claim 1, wherein the additive component includes functionalized activated carbon cross-linked with mangrove particles.

4. The membrane of claim 3, wherein the functionalized activated carbon is positively charged and the mangrove particles are negatively charged.

5. The membrane of claim 1, wherein the weight percentage of the additive component in the composite membrane ranges from about 1 wt. % to about 15 wt. %.

6. The membrane of claim 1, wherein the weight percentage of the additive component in the composite membrane ranges from about 2 wt. % to about 6 wt. %.

7. The membrane of claim 1, wherein the additive component is homogenously distributed within the polylactic acid polymer, and wherein pores of the membrane are sufficient for ultrafiltration.

8. The membrane of claim 1, wherein the additive component is in contact with pores of the composite polymeric membrane.

9. The membrane of claim 1, wherein a mean pore diameter of the composite polymeric membrane ranges from about 0.1 μm to about 0.6 μm.

10. A method of filtering a liquid, the method comprising:
contacting a liquid with a composite polymeric membrane, wherein the liquid includes one or more metals and the membrane includes an additive component and a polylactic acid polymer, and wherein the additive component includes activated carbon functionalized with polyethylenimine.

11. The method of claim 10 further including increasing the pH of the liquid sufficient to modify the membrane pore structure or surface charge.

12. The method of claim 10, wherein the liquid includes water and the metal includes one or more of copper, lead, and nickel.

13. The method of claim 10, wherein the metal includes one or more of copper, lead, nickel, manganese, cadmium, mercury, zinc, and arsenic.

14. The method of claim 10, wherein a mean pore diameter of the composite polymeric membrane ranges from about 0.1 μm to about 0.6 μm.

15. The method of claim 10, wherein the additive component includes functionalized activated carbon cross-linked with mangrove particles.

16. The method of claim 10, wherein the weight percentage of the additive component in the composite membrane ranges from about 1 wt. % to about 6 wt. %.

17. A method of forming a filtration membrane, the method comprising:
contacting an additive component with a solvent to form a solution, wherein the additive component includes activated carbon functionalized with polyethylenimine;
contacting the solution with polylactic acid;
heating the solution at a temperature above 40° C.;
removing gas from the solution; and
shaping the degassed solution to form a structure.

18. The method of claim 17, wherein the polylactic acid includes solid polylactic acid polymer beads, and wherein the additive component includes functionalized activated carbon cross-linked with mangrove particles.

19. The method of claim 17, wherein removing gas from the solution includes one or more of sonicating the solution and applying vacuum to the solution, and wherein shaping the degassed solution includes spreading the degassed solution on a support and placing the support in a coagulation bath.

20. The method of claim 17 further including dissolving polyvinylpyrrolidone in the solvent, wherein the solvent includes dimethylacetamide, and wherein the weight percentage of the additive component in the membrane ranges from about 1 wt. % to about 6 wt. %.
